(19) United States
(12) Patent Application Publication
(10) Pub. No.: US 2025/0286218 A1
(43) Pub. Date: Sep. 11, 2025

(54) SECONDARY BATTERY AND ELECTRICAL DEVICE

(71) Applicant: Ningde Amperex Technology Limited, Ningde (CN)

(72) Inventor: Meina YAO, Ningde (CN)

(73) Assignee: Ningde Amperex Technology Limited, Ningde (CN)

(21) Appl. No.: 19/075,810

(22) Filed: Mar. 11, 2025

(30) Foreign Application Priority Data
Mar. 11, 2024 (CN) 202410274984.6

(51) Int. Cl. H01M 50/446; H01M 10/0587; H01M 50/426; H01M 50/434; H01M 50/449

(52) U.S. Cl. CPC H01M 50/446; H01M 10/0587; H01M 50/426; H01M 50/434; H01M 50/449

(57) ABSTRACT

A secondary battery employs a first separator and second separator that are of different types. A first binder in a first bonding layer and first ceramic particles in a first ceramic coating of the first separator are regulated to fall within the ranges specified herein, and a second binder in a second bonding layer and second ceramic particles in a second ceramic coating of the second separator are regulated to fall within the ranges specified herein, thereby increasing the bonding force between the first separator and the negative electrode plate as well as the bonding force between the second separator and the positive and negative electrode plates.

### CROSS-REFERENCE TO RELATED APPLICATION

This application claims priority to Chinese Patent Application No. 202410274984.6 filed on Mar. 11, 2024, the entire content of which is incorporated herein by reference

### TECHNICAL FIELD

This application relates to the technical field of electrochemistry, and in particular, to a secondary battery and an electrical device.

### BACKGROUND

By virtue of the advantages such as a high energy density, a long cycle life, a low self-discharge rate, and environmental friendliness and no pollution, secondary batteries (such as lithium-ion batteries) have been widely used in the fields such as aviation, aerospace, marine navigation, electric vehicles, and mobile devices. A lithium-ion battery is formed of components such as a positive electrode plate, a negative electrode plate, and a separator. The performance of the separator decides an interface structure, an internal resistance, and the like of the lithium-ion battery, and directly affects the capacity, cycle performance, safety performance, and other characteristics of the lithium-ion battery. A separator of excellent performance is essential for improving the overall performance of the lithium-ion battery. The separator in the prior art is typically overlaid with a ceramic coating and a bonding layer on a base film. The ceramic coating can prevent the base film from shrinking at high temperature, and play a role in retaining an electrolyte solution. The bonding layer can increase adhesion between the electrode plate and the separator, prevent the separator from shrinking, expel the air in interstices inside the lithium-ion battery, increase the hardness of the lithium-ion battery, and maintain thickness consistency of the lithium-ion battery, thereby improving the stability of the lithium-ion battery during cycling. However, an existing separator applied in a lithium-ion battery is usually unable to achieve a desirable level of expansion resistance, cycle performance, and thermal abuse resistance of the lithium-ion battery simultaneously.

### SUMMARY

An objective of this application is to provide a secondary battery that can achieve a desirable level of expansion resistance, cycle performance, and thermal abuse resistance of the secondary battery simultaneously, and to provide an electrical device that employs the secondary battery.

It is hereby noted that in the description hereof, this application is construed by using a lithium-ion battery as an example of the secondary battery, but the secondary battery of this application is not limited to the lithium-ion battery. Specific technical solutions are described below.

A first aspect of this application provides a secondary battery. The secondary battery includes an electrode assembly. The electrode assembly is a jelly-roll structure. The electrode assembly includes a positive electrode plate, a negative electrode plate, a first separator, and a second separator. The first separator includes a first base film, a first bonding layer, and a first ceramic coating. The first bonding layer is disposed on both sides of the first base film. The first ceramic coating is disposed on at least one side of the first base film and is located between the first base film and the first bonding layer. The first bonding layer includes a first binder. The first binder includes at least one of polyvinylidene fluoride or poly(vinylidene fluoride-co-hexafluoropropylene). The first ceramic coating includes first ceramic particles. The first ceramic particles include at least one of aluminum oxide, zirconium dioxide, titanium dioxide, or silicon dioxide. The second separator includes a second base film, a second bonding layer, and a second ceramic coating. The second bonding layer is disposed on both sides of the second base film. The second ceramic coating is disposed on at least one side of the second base film and is located between the second base film and the second bonding layer. The second bonding layer includes a second binder. The second binder includes at least one of polyimide, polyvinyl alcohol, or sodium carboxymethyl cellulose. The second ceramic coating includes second ceramic particles. The second ceramic particles include boehmite.

The ceramic coating in an existing separator is typically classed into two types: oxide coating and boehmite coating, both exerting a great impact on the performance of secondary batteries. The oxide coating is highly wettable and highly capable of absorbing and retaining an electrolyte solution, thereby improving the cycle performance of the secondary battery. However, the oxide is of high hardness, causes great wear on a machine, and gives rise high cost of equipment. In addition, the oxide possesses a large specific gravity and is not flame retardant, thereby being detrimental to the energy density and safety of the secondary battery. Compared with oxides, boehmite is of low hardness, high heat resistance, low density, and good adhesiveness, and can improve the heat resistance and puncture resistance of the separator and improve the safety performance and energy density of the secondary battery. However, boehmite is not much wettable by an electrolyte solution, and is detrimental to electrolyte solution retention and the cycle performance of the secondary battery.

The binders in the bonding layer of existing separators typically include a low-melting binder (melting at approximately 115° C. to 170° C.) such as polyvinylidene fluoride (PVDF) or poly(vinylidene fluoride-co-hexafluoropropylene) (PVDF-HFP), and a high-melting binder (melting at more than 200° C.) such as polyimide (PI), polyvinyl alcohol (PVA), or sodium carboxymethyl cellulose (CMC-Na). The PVDF or PVDF-HFP exhibit the advantages such as low crystallinity and glass transition temperature, excellent compatibility with an electrolyte solution, and high adhesiveness to an electrode plate. However, due to a low melting point, when an external temperature is close to the melting point of the binder, the binder melts and is unable to effectively adhere to the ceramic coating, and therefore, is unable to further prevent shrinkage of the base film of the separator. The PI, PVA, and CMC-Na can effectively adhere to the ceramic coating at higher temperatures, thereby improving the high-temperature safety and stability of the secondary battery. However, such binders are unable to swell in the electrolyte solution like PVDF and PVDF-HFP, and are of low ionic conductivity. Therefore, the PI, PVA, and CMC-Na are detrimental to the cycle performance of the secondary battery.

In this application, the first separator is prepared from the above first binder together with the first ceramic particles, and the second separator is prepared from the above second binder together with the second ceramic particles. When the first separator and the second separator are used in combination, the advantages of each material can be effectively brought into play, thereby not only ensuring good adhesion between the separator and the electrode plate, but also increasing the hardness of the secondary battery, improving the thickness consistency of the secondary battery, and in turn, improving the stability of the secondary battery during cycling and the expansion resistance of the secondary battery. The oxide ceramic coating is of high electrolyte retainability but low adhesiveness. Therefore, the oxide ceramic coating combined with the PVDF or PVDF-HFP that swells sufficiently in the electrolyte solution and adheres firmly at normal temperature not only implements strong adhesion between the first separator and the electrode have, but also endows the secondary battery with good cycle performance. The boehmite ceramic coating is of high adhesiveness and heat resistance, and the boehmite serves a function of promoting the swelling of the binder in the electrolyte solution. Therefore, the boehmite combined with the high-melting PI, PVA, and CMC-Na bonding layer can greatly increase the normal-temperature adhesiveness between the second separator and the electrode plate while improving the high-temperature performance of the second separator. The first separator and the second separator are of relatively high mechanical strength, and can slow down the shrinkage of the first separator and the second separator during cycling of the secondary battery in a high-temperature environment, and can reduce the probability of a short circuit caused by contact between the positive electrode plate and the negative electrode plate, where the contact is caused by the shrinkage of the separator during charge and discharge of the secondary battery, thereby improving the thermal abuse resistance of the secondary battery. In addition, the first separator and the second separator are of high wettability and electrolyte retainability, thereby improving the cycle performance of the secondary battery. Therefore, the secondary battery of this application uses a first separator and a second separator of different types in combination, and controls the types of the first ceramic particles and the first binder in the first separator as well as the types of the second ceramic particles and the second binder in the second separator to fall within the ranges specified herein. In this way, the separators are of high adhesion to the positive electrode plate and/or negative electrode plate, and the secondary battery achieves a desirable level of expansion resistance, cycle performance, and thermal abuse resistance simultaneously.

In some embodiments of this application, the first binder includes poly(vinylidene fluoride-co-hexafluoropropylene), the first ceramic particles include aluminum oxide, the second binder includes polyimide, and the second ceramic particles include boehmite. The above first binder, first ceramic particles, second binder, and second ceramic particles can further improve the expansion resistance, cycle performance, and thermal abuse resistance of the secondary battery.

In some embodiments of this application, the negative electrode plate is located between the first separator and the second separator. The negative electrode plate includes a negative current collector as well as a first negative electrode material layer and a second negative electrode material layer disposed on two sides of the negative current collector respectively. Along a winding direction of the electrode assembly, a length of the first negative electrode material layer is greater than a length of the second negative electrode material layer. The first separator is disposed on a side, on which the first negative electrode material layer is located, of the negative electrode plate. The second separator is disposed on a side, on which the second negative electrode material layer is located, of the negative electrode plate. The boehmite makes the second separator more resistant to heat and puncture. Therefore, disposing the second separator between the positive electrode plate and the negative electrode plate can prevent a short circuit between the positive electrode and the negative electrode of the secondary battery under working conditions such as high temperature and puncture. The first ceramic particles allow the first separator to be more wettable and more capable of absorbing and retaining the electrolyte solution, thereby improving the cycle performance of the secondary battery. The first separator is disposed on a side, on which the relatively long first negative electrode material layer is located, of the negative electrode plate, thereby allowing a larger amount of negative active material to contact a larger amount of the electrolyte solution, further improving the cycle performance of the secondary battery, and preventing lithium plating. The above arrangement improves the cycle performance of the secondary battery while achieving a desirable level of both energy density and safety performance.

In some embodiments of this application, the first ceramic coating is disposed on both sides of the first base film. By disposing the first ceramic coating on both sides of the first base film, this application enables the first separator to store more electrolyte solution, and further improves the cycle performance of the secondary battery while achieving a desirable level of both expansion resistance and thermal abuse resistance.

In some embodiments of this application, the second separator is located between the positive electrode plate and the negative electrode plate. The second ceramic coating is disposed on just one side of the second base film, the side facing away from the negative electrode plate. First, as mentioned above, with other conditions being the same, the heat resistance of the second separator is significantly superior to the first separator. Therefore, by disposing the second separator between the positive electrode plate and the negative electrode plate, this application can prevent a short circuit between the positive electrode plate and the negative electrode plate at high temperature. Second, the positive active material particles on the positive electrode plate are relatively hard, some positive active material particles that are relatively large-sized or pointy occasionally protrude from the positive electrode plate. In a process of producing or using the secondary battery, such positive active material particles may pierce the separator between the positive electrode plate and the negative electrode plate and cause a short circuit between the positive electrode plate and the negative electrode plate. The second ceramic coating on the second separator is disposed on just one side of the second base film, the side facing away from the negative electrode plate. In other words, the second ceramic coating faces the positive electrode plate. The boehmite can improve the puncture resistance of the separator, thereby reducing the probability of the positive active material piercing the separator, and protecting the second base film more securely. In addition, a single-layer second ceramic coating can reduce the cost and increase the energy density of the secondary battery while further improving the safety performance.

In some embodiments of this application, an average particle diameter of the first ceramic particles is 0.2 μm to 1.2 μm, and an average particle diameter of the second ceramic particles is 0.1 μm to 1.0 μm. Controlling the average particle diameters of the first ceramic particles and the second ceramic particles to fall within the above ranges can further improve the cycle performance of the secondary battery while achieving a high level of energy density, expansion resistance, and safety performance simultaneously.

In some embodiments of this application, a thickness of the first ceramic coating is 0.5 μm to 2.5 μm, and a thickness of the second ceramic coating is 0.3 μm to 2.5 μm. Controlling the thicknesses of the first ceramic coating and the second ceramic coating to fall within the above ranges can further increase the energy density of the secondary battery while achieving a desirable level of cycle performance, expansion resistance, and safety performance of the secondary battery.

In some embodiments of this application, based on a mass of the first ceramic coating, a mass percent of the first ceramic particles is 10% to 50%; and, based on a mass of the second ceramic coating, a mass percent of the second ceramic particles is 10% to 50%. The mass percent of the first ceramic particles in the first ceramic coating and the mass percent of the second ceramic particles in the second ceramic coating are controlled within the above ranges, so that the content of the ceramic particles in the ceramic coating is sufficient and the ceramic particles can play a corresponding role sufficiently. In addition, the above settings achieve both a high energy density and low manufacture cost of the secondary battery, and endow the secondary battery with a high level of cycle performance, expansion resistance, and thermal abuse resistance.

In some embodiments of this application, a thickness of the first bonding layer is 0.2 μm to 5 μm, and a thickness of the second bonding layer is 0.2 μm to 5 μm. The thicknesses of the first bonding layer and the second bonding layer are controlled within the above ranges, so that the first separator and the second separator are of high adhesion to the positive electrode plate and/or negative electrode plate, and the secondary battery exhibits a high level of expansion resistance, cycle performance, thermal abuse resistance, and energy density simultaneously.

In some embodiments of this application, a material of the first base film and a material of the second base film each independently include at least one of polyimide, polyamide, polysulfone, polyacrylonitrile, cellulose, polyetheretherketone, polyphenylene sulfide, polyacrylate ester, polyethylene terephthalate, poly(p-benzamide), polyarylethersulfoneketone, aramid fiber, poly(aromatic sulfone) fiber, or polyolefin; and polymerization monomers of the polyolefin include at least one of ethylene, propylene, 1-butene, 1-pentene, 1-hexene, 1-octene, 4-methyl-1-pentene, cyclobutene, cyclopentene, or cyclohexene. The first base film and the second base film made of the materials specified above are of relatively high strength and ionic conductivity, thereby endowing the first separator and the second separator with good basic strength and ionic conductivity, and improving the expansion resistance, thermal abuse resistance, and cycle performance of the secondary battery.

A second aspect of this application provides an electrical device. The electrical device includes the secondary battery disclosed in any one of the above embodiments. Therefore, the electrical device exhibits superior operating performance.

Some of the beneficial effects of this application are as follows:

This application provides a secondary battery and an electrical device. The secondary battery employs a first separator and second separator that are of different types. A first binder in a first bonding layer and first ceramic particles in a first ceramic coating of the first separator are regulated to fall within the ranges specified herein, and a second binder in a second bonding layer and second ceramic particles in a second ceramic coating of the second separator are regulated to fall within the ranges specified herein, thereby increasing the adhesion between the first separator and the negative electrode plate as well as the adhesion between the second separator and the positive and negative electrode plates. The secondary battery can achieve a desirable level of expansion resistance, cycle performance, and thermal abuse resistance simultaneously.

Definitely, a single product or method in which the technical solution of this application is implemented does not necessarily achieve all of the above advantages concurrently.

### BRIEF DESCRIPTION OF DRAWINGS

To describe the technical solutions in some embodiments of this application or the prior art more clearly, the following outlines the drawings to be used in the description of some embodiments of this application or the prior art. Evidently, the drawings outlined below merely illustrate some embodiments of this application, and a person of ordinary skill in the art may derive other embodiments from the drawings.

FIG. 1 is a schematic diagram of a partial structure of an electrode assembly unwound along a winding direction according to some embodiments of this application;

FIG. 2 is a schematic diagram of a partial structure of an electrode assembly unwound along a winding direction according to some other embodiments of this application;

FIG. 3 is a cross-sectional schematic view of a first separator in an unwound state sectioned along a thickness direction and a width direction of the first separator according to some embodiments of this application;

FIG. 4 is a cross-sectional schematic view of a second separator in an unwound state sectioned along a thickness direction and a width direction of the second separator according to some embodiments of this application; and

FIG. 5 is a schematic diagram of a partial structure of an electrode assembly unwound along a winding direction according to some embodiments of this application.

### LIST OF REFERENCE NUMERALS

electrode assembly 100; first separator 10; first base film 11; first bonding layer 12; first ceramic coating 13; second separator 20; second base film 21; second bonding layer 22; second ceramic coating 23; negative electrode plate 30; negative current collector 31; first negative electrode material layer 33; second negative electrode material layer 34; positive electrode plate 40; positive current collector 41; positive electrode material layer 42.

### DETAILED DESCRIPTION

The following describes the technical solutions in some embodiments of this application clearly in detail with reference to the drawings appended hereto. Evidently, the described embodiments are merely a part of but not all of the embodiments of this application. All other embodiments derived by a person skilled in the art based on this application still fall within the protection scope of this application.

It is hereby noted that in specific embodiments of this application, this application is construed by using a lithium-ion battery as an example of the secondary battery, but the secondary battery of this application is not limited to the lithium-ion battery.

A first aspect of this application provides a secondary battery. The secondary battery includes an electrode assembly. The electrode assembly is a jelly-roll structure. The electrode assembly includes a positive electrode plate, a negative electrode plate, a first separator, and a second separator. The first separator includes a first base film, a first bonding layer, and a first ceramic coating. The first bonding layer is disposed on both sides of the first base film. The first ceramic coating is disposed on at least one side of the first base film and is located between the first base film and the first bonding layer. The “first ceramic coating is disposed on at least one side of the first base film” means that the first ceramic coating is disposed on either side of the first base film or on both sides of the first base film. On one side, uncoated with the first ceramic coating, of the first base film, the first bonding layer is directly disposed on the surface of the first base film. The first bonding layer includes a first binder. The first binder includes at least one of polyvinylidene fluoride or poly(vinylidene fluoride-co-hexafluoropropylene). The first ceramic coating includes first ceramic particles. The first ceramic particles include at least one of aluminum oxide, zirconium dioxide, titanium dioxide, or silicon dioxide. The second separator includes a second base film, a second bonding layer, and a second ceramic coating. The second bonding layer is disposed on both sides of the second base film. The second ceramic coating is disposed on at least one side of the second base film and is located between the second base film and the second bonding layer. The “second ceramic coating is disposed on at least one side of the second base film” means that the second ceramic coating is disposed on either side of the second base film or on both sides of the second base film. On one side, uncoated with the second ceramic coating, of the second base film, the second bonding layer is directly disposed on the surface of the second base film. The second bonding layer includes a second binder. The second binder includes at least one of polyimide, polyvinyl alcohol, or sodium carboxymethyl cellulose. The second ceramic coating includes second ceramic particles. The second ceramic particles include boehmite.

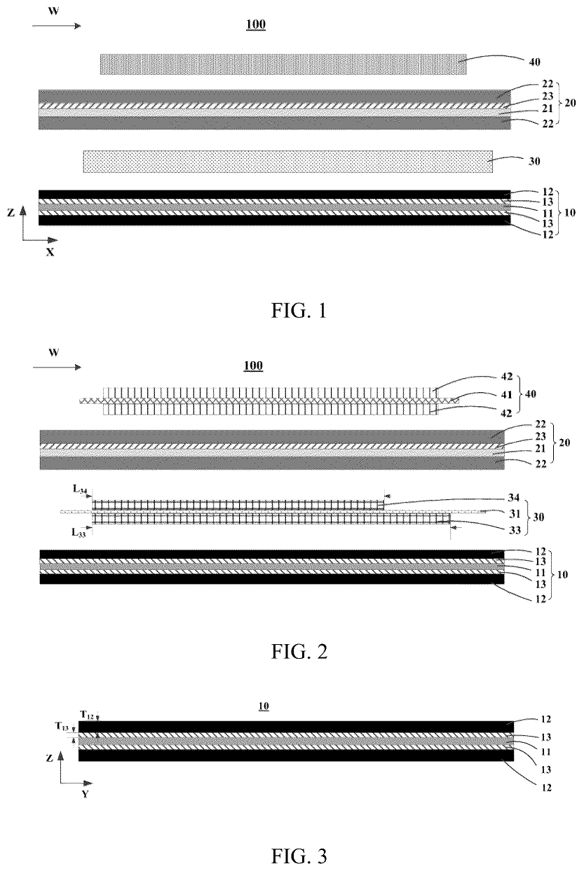

In this application, the structure of the electrode assembly is a jelly-roll structure. The winding direction of the electrode assembly is defined as W. A person skilled in the art understands that the winding direction of the positive electrode plate, the negative electrode plate, the first separator, and the second separator is the same as the winding direction of the electrode assembly. To facilitate understanding of the positional relationship between the positive electrode plate, the negative electrode plate, the first separator, and the second separator in the electrode assembly, FIG. 1 shows a schematic diagram of a partial structure of the electrode assembly unwound along the winding direction W. In this application, the length direction of the positive electrode plate, the negative electrode plate, the first separator, and the second separator in an unwound state is defined as X, the width direction thereof is defined as Y, and the thickness direction thereof is defined as Z. Understandably, in the schematic diagram of the structure of the electrode assembly unwound along the winding direction W, the winding direction W is parallel to the length direction X. As shown in FIG. 1, the electrode assembly 100 includes a first separator 10, a second separator 20, a negative electrode plate 30, and a positive electrode plate 40. The negative electrode plate 30 is located between the first separator 10 and the second separator 20. The second separator 20 is located between the negative electrode plate 30 and the positive electrode plate 40. The positive electrode plate 40 is located at the outermost layer of the electrode assembly 100. The first separator 10 includes a first base film 11, a first bonding layer 12, and a first ceramic coating 13. The first bonding layer 12 is located on both sides of the first base film 11. The first ceramic coating 13 is located on both sides of the first base film 11. The first ceramic coating 13 is located between the first base film 11 and the first bonding layer 12. Understandably, in some embodiments, the first ceramic coating 13 may be disposed on a surface of the first base film 11 on a side facing away from the negative electrode plate 30. In some other embodiments, the first ceramic coating 13 may be disposed on a surface of the first base film 11 on a side close to the negative electrode plate 30. If the first ceramic coating 13 is disposed on the surface of the first base film 11 on just one side, then on the side overlaid with the first ceramic coating 13, the first ceramic coating 13 is located between the first base film 11 and the first bonding layer 12; and, on the side overlaid with no first ceramic coating 13, the first bonding layer 12 is directly disposed on the surface of the first base film 11. The second separator 20 includes a second base film 21, a second bonding layer 22, and a second ceramic coating 23. The second bonding layer 22 is located on both sides of the second base film 21. The second ceramic coating 23 is located on a surface of the second base film 21 on a side facing away from the negative electrode plate 30. The second ceramic coating 23 is located between the second base film 21 and the second bonding layer 22. On the surface of the second base film 22 on the side overlaid with no second ceramic coating 23, that is, on the surface of the second base film 22 on the side close to the negative electrode plate 30, the second bonding layer 22 is disposed on the surface of the second base film 21 directly. Understandably, in some embodiments, the second ceramic coating 23 in the second separator 20 may be disposed on the surface of the second base film 21 on the side close to the negative electrode plate 30. In some other embodiments, the second ceramic coating 23 in the second separator 20 may be disposed on both sides of the second base film 21.

The polyvinylidene fluoride and the poly(vinylidene fluoride-co-hexafluoropropylene) are of relatively low crystallinity and glass transition temperature, and, when used as a binder in the separator, are well compatible with the electrolyte solution and are of good adhesiveness to the positive electrode plate or negative electrode plate. When used as a separator binder, the polyimide, the polyvinyl alcohol, and the sodium carboxymethyl cellulose can adhere to the ceramic particles in the ceramic coating at a higher temperature, thereby implementing firm adhesion between the ceramic coating and the bonding layer. In addition, the swelling degree of the separator binder in the electrolyte solution is low, so that the probability of the separator expanding in the electrolyte solution is low, thereby improving the expansion resistance of the secondary battery.

The first ceramic particles are well wettable and capable of absorbing and retaining electrolyte solution. The above first ceramic particles applied in the first ceramic coating can improve the electrolyte storage capacity and wettability of the first separator, thereby improving the cycle performance of the secondary battery. The second ceramic particles are highly resistant to heat and puncture and are of a low density. The above second ceramic particles applied in the second ceramic coating can slow down the shrinkage of the second separator at high temperature, and reduce the probability of a short circuit of the secondary battery caused by contact between the positive electrode plate and the negative electrode plate, where the contact is caused by the shrinkage of the second separator during charge and discharge of the secondary battery, thereby improving the capability of binding the second separator, and in turn, improving the thermal abuse resistance of the secondary battery.

In this application, the first separator is prepared from the above first binder together with the first ceramic particles, and the second separator is prepared from the above second binder together with the second ceramic particles. When the first separator and the second separator are used in combination, the advantages of each material can be effectively brought into play, thereby not only ensuring good adhesion between the separator and the electrode plate, but also increasing the hardness of the secondary battery, improving the thickness consistency of the secondary battery, and in turn, improving the stability of the secondary battery during cycling and the expansion resistance of the secondary battery. The oxide ceramic coating is of high electrolyte retainability but low adhesiveness. Therefore, the oxide ceramic coating combined with the PVDF or PVDF-HFP that swells sufficiently in the electrolyte solution and adheres firmly at normal temperature not only implements strong adhesion between the first separator and the electrode have, but also endows the secondary battery with good cycle performance. The boehmite ceramic coating is of high adhesiveness and heat resistance, and the boehmite serves a function of promoting the swelling of the binder in the electrolyte solution. Therefore, the boehmite combined with the high-melting PI, PVA, and CMC-Na bonding layer can greatly increase the normal-temperature adhesiveness between the second separator and the electrode plate while improving the high-temperature performance of the second separator. The first separator and the second separator are of relatively high mechanical strength, and can slow down the shrinkage of the first separator and the second separator during cycling of the secondary battery in a high-temperature environment, and can reduce the probability of a short circuit caused by contact between the positive electrode plate and the negative electrode plate, where the contact is caused by the shrinkage of the separator during charge and discharge of the secondary battery, thereby improving the thermal abuse resistance of the secondary battery. In addition, the first separator and the second separator are of high wettability and electrolyte retainability, thereby improving the cycle performance of the secondary battery. Therefore, the secondary battery of this application uses a first separator and a second separator of different types in combination, and controls the types of the first ceramic particles and the first binder in the first separator as well as the types of the second ceramic particles and the second binder in the second separator to fall within the ranges specified herein. In this way, the separators are of high adhesion to the positive electrode plate and/or negative electrode plate, and the secondary battery achieves a desirable level of expansion resistance, cycle performance, and thermal abuse resistance simultaneously.

In some embodiments of this application, the first binder includes poly(vinylidene fluoride-co-hexafluoropropylene), the first ceramic particles include aluminum oxide, the second binder includes polyimide, and the second ceramic particles include boehmite. The above first binder, first ceramic particles, second binder, and second ceramic particles can further improve the adhesion of the separator to the positive electrode plate and/or negative electrode plate, and further improve the expansion resistance, cycle performance, and thermal abuse resistance of the secondary battery.

In some embodiments of this application, the negative electrode plate includes a negative current collector as well as a first negative electrode material layer and a second negative electrode material layer disposed on two sides of the negative current collector respectively. Along a winding direction of the electrode assembly, a length of the first negative electrode material layer is greater than a length of the second negative electrode material layer. The first separator is disposed on a side, on which the first negative electrode material layer is located, of the negative electrode plate. The second separator is disposed on a side, on which the second negative electrode material layer is located, of the negative electrode plate. As shown in FIG. 2, the electrode assembly 100 includes a first separator 10, a second separator 20, a negative electrode plate 30, and a positive electrode plate 40. The negative electrode plate 30 is located between the first separator 10 and the second separator 20. The second separator 20 is located between the positive electrode plate 40 and the negative electrode plate 30. The positive electrode plate 40 includes a positive current collector 41 as well as a positive electrode material layer 42 disposed on two sides of the positive current collector 41. The negative electrode plate 30 includes a negative current collector 31 as well as a first negative electrode material layer 33 and a second negative electrode material layer 34 disposed on two sides of the negative current collector 31 respectively. Along a winding direction W of the electrode assembly 100, a length L33 of the first negative electrode material layer 33 is greater than a length L34 of the second negative electrode material layer 34. The first separator 10 is disposed on a side, on which the first negative electrode material layer 33 is located, of the negative electrode plate 30. In other words, the first separator 10 is adjacent to the first negative electrode material layer 33. The second separator 20 is disposed on a side, on which the second negative electrode material layer 34 is located, of the negative electrode plate 30. In other words, the second separator 20 is adjacent to the second negative electrode material layer 34. The boehmite makes the second separator more resistant to heat and puncture. Therefore, disposing the second separator between the positive electrode plate and the negative electrode plate can prevent a short circuit between the positive electrode and the negative electrode of the secondary battery under working conditions such as high temperature and puncture. The oxide ceramic allows the first separator to be more wettable and more capable of absorbing and retaining the electrolyte solution, thereby improving the cycle performance of the secondary battery. The first separator is disposed on a side, on which the relatively long first negative electrode material layer is located, of the negative electrode plate, thereby allowing a larger amount of negative active material to contact a larger amount of the electrolyte solution, further improving the cycle performance of the secondary battery, and preventing lithium plating. The above arrangement improves the cycle performance of the secondary battery while achieving a desirable level of both energy density and safety performance.

In some embodiments of this application, the first ceramic coating is disposed on both sides of the first base film. As shown in FIG. 3, the first separator 10 includes a first base film 11 and a first ceramic coating 13. The first ceramic coating 13 is disposed on both sides of the first base film 11. By disposing the first ceramic coating on both sides of the first base film, this application further improves the electrolyte storage capacity and wettability of the first separator, enables the first separator to store more electrolyte solution, and further improves the electrolyte storage capacity and wettability of the secondary battery. Such an arrangement further improves the cycle performance of the secondary battery while achieving a desirable level of both expansion resistance and thermal abuse resistance.

In some embodiments of this application, the second separator is located between the positive electrode plate and the negative electrode plate. The second ceramic coating is disposed on just one side of the second base film, the side facing away from the negative electrode plate. As shown in FIGS. 1 and 2, the second separator 20 is located between the positive electrode plate 40 and the negative electrode plate 30. The second separator 20 includes a second base film 21, a second bonding layer 22, and a second ceramic coating 23. The second bonding layer 22 is located on both sides of the second base film 21. The second ceramic coating 23 is disposed on just one side of the second base film 21, the side facing away from the negative electrode plate 30. In other words, the second ceramic coating 23 is disposed on one side of the second base film 21, the side being close to and facing the positive electrode plate 40. No second ceramic coating 23 is disposed on a side, close to the negative electrode plate 30, of the second base film 21. The second separator is disposed between the positive electrode plate and the negative electrode plate to prevent a short circuit between the positive electrode plate and the negative electrode plate. When the positive active material particles in the positive electrode plate are large-sized or pointy, the positive active material particles may squeeze or even pierce the separator between the positive electrode plate and the negative electrode plate in a process of producing or using the secondary battery, thereby causing a short circuit between the positive electrode plate and the negative electrode plate. Through the above arrangement, the second ceramic coating is disposed on one side of the second base film, the side facing away from the negative electrode plate. In other words, the second ceramic coating faces the positive electrode plate. The boehmite can improve the puncture resistance of the separator, thereby reducing the probability of the large-sized or pointy positive active material particles piercing the second separator, protecting the second base film more securely, and in turn, improving the safety performance of the secondary battery. In addition, the second ceramic coating is disposed on just one side of the second base film, thereby reducing the thickness of the second separator, reducing the thickness of the secondary battery, and in turn, increasing the energy density of the secondary battery. Therefore, this application further improves the safety performance and energy density of the secondary battery while achieving good cycle performance of the secondary battery.

In some embodiments of this application, an average particle diameter of the first ceramic particles is 0.2 μm to 1.2 μm, and an average particle diameter of the second ceramic particles is 0.1 μm to 1.0 μm. For example, the average particle diameter of the first ceramic particles is 0.2 μm, 0.4 μm, 0.6 μm, 0.8 μm, 1.0 μm, 1.2 μm, or any value falling within a range formed any two thereof. For example, the average particle diameter of the second ceramic particles is 0.1 μm, 0.2 μm, 0.3 μm, 0.4 μm, 0.5 μm, 0.6 m, 0.7 μm, 0.8 μm, 0.9 μm, 1.0 μm, or any value falling within a range formed any two thereof. The average particle diameters of the first ceramic particles and the second ceramic particles are controlled to fall within the above ranges, so that the first ceramic particles and the second ceramic particles possess a relatively large specific surface area, thereby improving the electrolyte storage capacity and wettability of the first separator and the second separator, and further improving the cycle performance of the secondary battery while achieving a high level of energy density, expansion resistance, and safety performance of the secondary battery simultaneously.

The methods for adjusting and controlling the average particle diameters of the first ceramic particles and the second ceramic particles are not particularly limited herein, as long as the objectives of this application can be achieved. For example, the average particle diameters may be adjusted and controlled by pulverization and sieving.

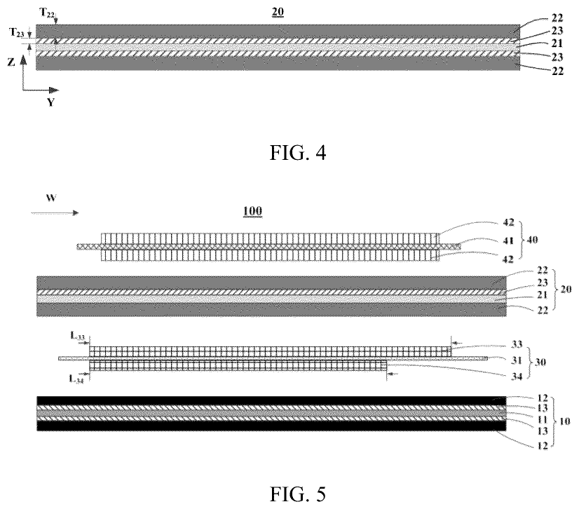

In some embodiments of this application, as shown in FIG. 3, a thickness T₁₃ of the first ceramic coating 13 is 0.5 μm to 2.5 μm; and, as shown in FIG. 4, a thickness T₂₃ of the second ceramic coating 23 is 0.3 μm to 2.5 μm. For example, the thickness of the first ceramic coating is 0.5 μm, 0.6 μm, 0.8 μm, 1.0 μm, 1.3 μm, 1.5 am, 1.8 μm, 2.0 μm, 2.2 μm, 2.5 μm, or any value falling within a range formed by any two thereof. For example, the thickness of the second ceramic coating is 0.3 μm, 0.6 am, 0.8 μm, 1.0 μm, 1.3 μm, 1.5 μm, 1.8 μm, 2.0 μm, 2.2 μm, 2.5 μm, or any value falling within a range formed by any two thereof. Controlling the thicknesses of the first ceramic coating and the second ceramic coating to fall within the above ranges contributes to a relatively small thickness of the first separator and the second separator and a relatively small size of the secondary battery, thereby further increasing the energy density of the secondary battery while achieving a desirable level of cycle performance, expansion resistance, and safety performance of the secondary battery.

In some embodiments of this application, based on a mass of the first ceramic coating, a mass percent of the first ceramic particles is 10% to 50%. For example, the mass percent of the first ceramic particles is 10%, 20%, 25%, 30%, 36%, 42%, 50%, or a value falling within a range formed by any two thereof. The mass percent of the first ceramic particles in the first ceramic coating is controlled within the above range, so that the content of the ceramic particles in the ceramic coating is sufficient and the ceramic particles can play a corresponding role sufficiently. The resultant first separator exhibits a high electrolyte storage capacity and high wettability. The first separator applied to a secondary battery contributes to good cycle performance in addition to high expansion resistance and thermal abuse resistance of the secondary battery.

In some embodiments of this application, based on a mass of the second ceramic coating, a mass percent of the second ceramic particles is 10% to 50%. For example, the mass percent of the second ceramic particles is 10%, 20%, 25%, 30%, 36%, 42%, 50%, or a value falling within a range formed by any two thereof. The mass percent of the second ceramic particles in the second ceramic coating is controlled within the above range, so that the resultant second ceramic coating exhibits good operating performance. Therefore, the resultant second separator exhibits high thermal stability and puncture resistance. The second separator applied to a secondary battery contributes to good thermal abuse resistance in addition to a high level of manufacture cost-effectiveness, expansion resistance, and cycle performance of the secondary battery.

In some embodiments of this application, the first ceramic coating further includes a first ceramic coating binder, and the second ceramic coating further includes a second ceramic coating binder. The types of the first ceramic coating binder and the second ceramic coating binder are not particularly limited herein, as long as the objectives of this application can be achieved. For example, the first ceramic coating binder and the second ceramic coating binder each independently include at least one of styrene-butadiene rubber, polyvinyl alcohol, polyvinylidene fluoride, polyacrylic acid, polymethyl methacrylate, polybutyl acrylate, or polyacrylonitrile. The content of the first ceramic coating binder in the first ceramic coating and the content of the second ceramic coating binder in the second ceramic coating are not particularly limited herein, and may be selected by a person skilled in the art as actually required, as long as the objectives of this application can be achieved. For example, based on the mass of the first ceramic coating, the mass percent of the first ceramic coating binder is 50% to 90%; and, based on the mass of the second ceramic coating, the mass percent of the second ceramic coating binder is 50% to 90%.

In some embodiments of this application, as shown in FIG. 3, the thickness T₁₂ of the first bonding layer 12 is 0.2 μm to 5 μm; and, as shown in FIG. 4, the thickness T₂₂ of the second bonding layer 22 is 0.2 μm to 5 μm. For example, the thickness of the first bonding layer is 0.2 μm, 1 μm, 2 μm, 3 μm, 4 μm, 5 μm, or a value falling within a range formed by any two thereof. For example, the thickness of the second bonding layer is 0.2 μm, 1 μm, 2 μm, 3 μm, 4 μm, 5 μm, or a value falling within a range formed by any two thereof. By controlling the thicknesses of the first bonding layer and the second bonding layer within the above ranges, this application controls the thicknesses of the first separator and the second separator to be relatively small, and therefore, downsizes the secondary battery, and reduces the risk that a large size impairs the energy density. In addition, the first bonding layer and the second bonding layer endow the first separator and the second separator, respectively, with good adhesiveness. In this way, the first separator and the second separator are of high adhesion to the positive electrode plate and/or negative electrode plate, and the secondary battery exhibits a high level of expansion resistance, cycle performance, thermal abuse resistance, and energy density simultaneously.

In some embodiments of this application, a material of the first base film and a material of the second base film each independently include at least one of polyimide, polyamide, polysulfone, polyacrylonitrile, cellulose, polyetheretherketone, polyphenylene sulfide, polyacrylate ester, polyethylene terephthalate, poly(p-benzamide), polyarylethersulfoneketone, aramid fiber, poly(aromatic sulfone) fiber, or polyolefin; and polymerization monomers of the polyolefin include at least one of ethylene, propylene, 1-butene, 1-pentene, 1-hexene, 1-octene, 4-methyl-1-pentene, cyclobutene, cyclopentene, or cyclohexene. When the first base film and the second base film are made of the materials specified above, a double separator structure including a first separator and a second separator can be disposed in the secondary battery, thereby improving the expansion resistance, thermal abuse resistance, and cycle performance of the secondary battery. The weight-average molecular weight of the material of the first base film is not particularly limited herein, as long as the objectives of this application can be achieved. For example, the weight-average molecular weight of the material of the first base film is 2×10⁵ to 1.5×10⁶. The weight-average molecular weight of the material of the second base film is not particularly limited herein, as long as the objectives of this application can be achieved. For example, the weight-average molecular weight of the material of the second base film is 2×10⁵ to 1.5×10⁶.

The thicknesses of the first base film and the second base film are not particularly limited herein, as long as the objectives of this application can be achieved.

The thicknesses of the first separator and the second separator are not particularly limited herein, as long as the objectives of this application can be achieved. For example, the thickness of the first separator is 12 μm to 25 μm, and the thickness of the second separator is 5 μm to 15 μm.

In some embodiments of this application, the first bonding layer may further include a first thickener, and the second bonding layer may further include a second thickener. Based on the mass of the first bonding layer, the mass percent of the first binder is 94% to 99.7%, and the mass percent of the first thickener is 0.3% to 6%. Based on the mass of the second bonding layer, the mass percent of the second binder is 94% to 99.7%, and the mass percent of the second thickener is 0.3% to 6%. Applying the first thickener to the first bonding layer and the second thickener to the second bonding layer can increase the stability of the first bonding layer slurry and the second bonding layer slurry, and prevent the sedimentation of each constituent in the first bonding layer slurry and the second bonding layer slurry. The types of the first thickener and the second thickener are not particularly limited herein, as long as the objectives of this application can be achieved. For example, the first thickener and the second thickener each independently are at least one selected from hydroxyethyl cellulose, methyl hydroxyethyl cellulose, sodium carboxymethyl cellulose, polyacrylamide, or sodium alginate.

The negative current collector is not particularly limited herein, as long as the objectives of this application can be achieved. For example, the negative current collector may be copper foil, copper alloy foil, nickel foil, stainless steel foil, titanium foil, foamed nickel, foamed copper, a composite current collector (such as a carbon copper composite current collector, a nickel copper composite current collector, or a titanium copper composite current collector), or the like. The first negative electrode material layer and the second negative electrode material layer of this application each independently contain a negative active material. The type of the negative active material is not particularly limited in this application, as long as the objectives of this application can be achieved. For example, the negative active material may include at least one of natural graphite, artificial graphite, mesocarbon microbeads (MCMB), hard carbon, soft carbon, silicon, a silicon-carbon composite, SiOₓ (0<×<2), Li—Sn alloy, Li—Sn—O alloy, Sn, SnO, SnO₂, spinel-structured lithium titanium oxide Li₄Ti₅Oi₂, Li—Al alloy, or metallic lithium. The thicknesses of the negative current collector, the first negative electrode material layer, and the second negative electrode material layer are not particularly limited herein, as long as the objectives of this application can be achieved. For example, the thickness of the negative current collector is 4 μm to 15 μm, the thickness of the first negative electrode material layer is 30 μm to 130 μm, and the thickness of the second negative electrode material layer is 30 μm to 130 μm. Optionally, the first negative electrode material layer and the second negative electrode material layer may further include a conductive agent and a binder. The mass ratio between the negative active material, conductive agent, and binder in the first negative electrode material layer and the second negative electrode material layer is not particularly limited herein, as long as the objectives of this application can be achieved.

In some embodiments of this application, the positive electrode plate includes a positive current collector and a positive electrode material layer disposed on one side or both sides of the positive current collector. The positive current collector is not particularly limited herein, as long as the objectives of this application can be achieved. For example, the positive current collector may include aluminum foil, aluminum alloy foil, a composite current collector (such as an aluminum carbon composite current collector), or the like. The positive electrode material layer of this application includes a positive active material. The type of the positive active material is not particularly limited herein, as long as the objectives of this application can be achieved. For example, the positive active material may include at least one of lithium nickel cobalt manganese oxide (NCM811, NCM622, NCM523, NCM111), lithium nickel cobalt aluminum oxide, lithium iron phosphate, a lithium-rich manganese-based material, lithium cobalt oxide (LiCoO₂), lithium manganese oxide, lithium manganese iron phosphate, lithium titanium oxide, or the like. In this application, the positive active material may further include a non-metal element. For example, the non-metal element includes, but is not limited to, at least one of fluorine, phosphorus, boron, chlorine, silicon, or sulfur. The thicknesses of the positive current collector and the positive electrode material layer are not particularly limited herein, as long as the objectives of this application can be achieved. For example, the thickness of the positive current collector is 9 μm to 15 μm, and the thickness of the positive electrode material layer on a single side is 30 μm to 120 μm. In this application, the positive electrode material layer may further include a conductive agent and a binder. The types of the conductive agent and the binder in the positive electrode material layer are not particularly limited herein, as long as the objectives of this application can be achieved. The mass ratio between the positive active material, the conductive agent, and the binder in the positive electrode material layer is not particularly limited herein, and may be selected by a person skilled in the art as actually required, as long as the objectives of this application can be achieved.

The types of the conductive agents in the positive electrode material layer, the first negative electrode material layer, and the second negative electrode material layer are not particularly limited herein, as long as the objectives of this application can be achieved. For example, the conductive agent may include, but is not limited to, at least one of conductive carbon black (Super P), carbon nanotubes (CNTs), carbon fibers, flake graphite, Ketjen black, graphene, a metal material, or a conductive polymer. The carbon nanotubes may include, but are not limited to, single-walled carbon nanotubes and/or multi-walled carbon nanotubes. The carbon fibers may include, but are not limited to, vapor grown carbon fibers (VGCF) and/or carbon nanofibers. The metal material may include, but is not limited to, metal powder and/or metal fibers. Specifically, the metal may include, but is not limited to, at least one of copper, nickel, aluminum, or silver. The conductive polymer may include, but is not limited to, at least one of polyphenylene derivatives, polyaniline, polythiophene, polyacetylene, or polypyrrole. The types of the binders in the positive electrode material layer, the first negative electrode material layer, and the second negative electrode material layer are not particularly limited herein, as long as the objectives of this application can be achieved. For example, the binder may include, but is not limited to, at least one of polyvinylidene fluoride, poly(vinylidene fluoride-co-hexafluoropropylene), polyamide, polyacrylonitrile, polyacrylate, polyacrylic acid, polyacrylic acid sodium salt, polyvinylpyrrolidone, polyvinyl ether, polymethyl methacrylate, polytetrafluoroethylene, or polyhexafluoropropylene. The positive electrode material layer, the first negative electrode material layer, and the second negative electrode material layer may contain the same type or different types of conductive agent and binder.

In some embodiments of this application, the secondary battery of this application further includes an electrolyte solution and a packaging bag. The electrode assembly and the electrolyte solution are accommodated in the packaging bag. The electrolyte solution and the packaging bag are not particularly limited herein, and an electrolyte solution and a packaging bag well known in the art may be selected by a person skilled in the art according to actual conditions, as long as the objectives of this application can be achieved.

The method for preparing the first separator is not particularly limited herein, as long as the objectives of this application can be achieved. For example, the preparation method of the first separator includes, but is not limited to, the following steps: (1) mixing the material of a first bonding layer with the first thickener well to obtain a first bonding layer slurry; (2) mixing first ceramic particles with a first ceramic coating binder well to obtain a first ceramic coating slurry; (3) applying the first ceramic coating slurry onto one surface of a first base film, oven-drying the slurry to form a first ceramic coating on one surface of the first base film, applying the first bonding layer slurry onto a surface of the first ceramic coating on a side away from the first base film, oven-drying the slurry to obtain a first separator coated with the first ceramic coating and the first bonding layer on one side; and (4) repeating the above steps on the other surface of the first base film to obtain a first separator. In an embodiment of this application, after step (3) above, the other surface of the first base film may be coated with only the first bonding layer slurry, and then oven-dried to obtain a first separator.

The method for preparing the second separator is not particularly limited herein, as long as the objectives of this application can be achieved. For example, the preparation method of the second separator includes, but is not limited to, the following steps: (1) mixing a second binder with a second thickener well to obtain a second bonding layer slurry; (2) mixing second ceramic particles with a second ceramic coating binder well to obtain a second ceramic coating slurry; (3) applying the second ceramic coating slurry onto one surface of a second base film, oven-drying the slurry to form a second ceramic coating on one surface of the second base film, applying the second bonding layer slurry onto a surface of the second ceramic coating on a side away from the second base film, oven-drying the slurry to obtain a second separator coated with the second ceramic coating and the second bonding layer on one side; and (4) repeating the above steps on the other surface of the second base film to obtain a second separator. In an embodiment of this application, after step (3) above, the other surface of the second base film may be coated with only the second bonding layer slurry, and then oven-dried to obtain a second separator.

The secondary battery is not particularly limited in this application, and may be any device in which an electrochemical reaction occurs. In an embodiment of this application, the secondary battery may be, but is not limited to, a lithium-ion secondary battery (lithium-ion battery), a sodium-ion secondary battery (sodium-ion battery), a lithium polymer secondary battery, a lithium-ion polymer secondary battery, or the like.

The method for preparing the secondary battery is not particularly limited herein, and may be any preparation method well-known in the art, as long as the objectives of this application can be achieved. For example, the method for preparing the secondary battery includes, but is not limited to, the following steps: stacking the positive electrode plate, the second separator, the negative electrode plate, and the first separator in sequence, and performing operations such as winding and folding as required on the stacked structure to obtain a jelly-roll electrode assembly; putting the electrode assembly into a packaging bag, injecting an electrolyte solution into the packaging bag, and sealing the package bag to obtain a secondary battery.

A second aspect of this application provides an electrical device. The electrical device includes the secondary battery disclosed in any one of the above embodiments. Therefore, the electrical device exhibits superior operating performance.

The electrical device of this application is not particularly limited herein, and may be any electrical device known in the prior art. For example, the electrical device may include, but is not limited to, a notebook computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, and lithium-ion capacitor.

### EMBODIMENTS

The implementations of this application are described below in more detail with reference to embodiments and comparative embodiments. Various tests and evaluations are performed by the following methods.

### Test Methods and Devices

### Method for Sampling First Separators and Second Separators:

Disassembling a lithium-ion battery in each embodiment and comparative embodiment to be tested, taking out a first separator and a second separator, and soaking the separators in dimethyl carbonate (DMC) for 20 minutes to remove residual electrolyte solution. Subsequently, drying the first separator and the second separator in an oven at 60° C. for 12 hours to obtain a first separator sample and a second separator sample. The samples in the following test of the average particle diameter the first ceramic particles and the second ceramic particles are obtained by the above method.

### Determining the Average Particle Diameters of the First Ceramic Particles and the Second Ceramic Particles

Sectioning the first separator or the second separator along a thickness direction of the separator by argon ion polishing to obtain a cross-section of the separator. Observing the cross-section of the first separator or the second separator by using a scanning electron microscope (SEM). Measuring the equivalent diameter of 10 first ceramic particles and the equivalent diameter of 10 second ceramic particles separately (that is, for a particle with an irregular cross-section, the equivalent diameter is the diameter of a circle of the same area as the particle). Averaging out the measured values to obtain an average particle diameter of the first ceramic particles or the average particle diameter of the second ceramic particles.

### Determining the Thicknesses of the First Ceramic Coating, the Second Ceramic Coating, the First Bonding Layer, and the Second Bonding Layer

Performing argon ion beam cross-section polishing on the first separator to obtain a cross-section of the first separator, and observing the morphology of the cross-section of the first separator along the thickness direction by using a field emission scanning electron microscope (XL-30, from Philips), and capturing a scanning electron microscope image. Measuring the thickness T₁₃ of the first ceramic coating and the thickness T₁₂ of the first bonding layer by using the scanning electron microscope.

Performing argon ion beam cross-section polishing on the second separator to obtain a cross-section of the second separator, and observing the morphology of the cross-section of the second separator along the thickness direction by using a field emission scanning electron microscope (XL-30, from Philips), and capturing a scanning electron microscope image. Measuring the thickness T₂₃ of the second ceramic coating and the thickness T₂₂ of the second bonding layer by using the scanning electron microscope.

### Testing the Adhesion of the Separator to the Electrode Plate

Measuring dry-pressing adhesion between the separator and the electrode plate with reference to a 1800 peeling test standard. Disassembling the lithium-ion batteries in the tested embodiment and comparative embodiment, and taking out the positive electrode plate, the negative electrode plate, the first separator, and the second separator. Soaking the to-be-tested electrode plate and separator in dimethyl carbonate for 20 minutes to remove the electrolyte solution, and then laminating the separator sample and the electrode plate sample, and hot-pressing the laminated plates by using a hot press at 85° C. under a pressure of 1 MPa for 85 seconds. Cutting the laminated sample into 15 mm×54.2 mm strips to obtain test strips for testing the adhesion of the separator sample to the electrode plate sample. Sticking a 15 mm×55 mm double-sided tape (Nitto No. 5000NS) to a steel sheet, and then sticking the test strip onto the double-sided tape, with the test side facing down. Connecting a 15 mm×70 mm paper strip to one end of the test strip by using double-sided tape, and pushing a small stick of a 2 kg weight by hand to roll on the test strip 8 times to obtain a specimen. Measuring the adhesion by using a tensile tester. Fixing the specimen onto a specimen bench, folding the paper strip upward by 180°, and fixing the paper strip with a jig. Subsequently, using a tensile tester to pull the paper strip at a speed of 50 mm/min until the separator sample on the surface of the double-sided tape is detached from the electrode plate sample. Recording the test data. Calculating the adhesion F (N/m) between the separator sample and the electrode plate sample based on the tensile force applied and the tensile displacement caused when the separator sample is detached from the electrode plate. The adhesion of the first separator to the negative electrode plate is F₁ in N/m; the adhesion of the second separator to the positive electrode plate is F₂ in N/m; and the adhesion of the second separator to the negative electrode plate is F₃ in N/m.

### High-Temperature Hot-Oven Test

Charging a lithium-ion battery at 25° C. at a constant current of 2C until the voltage reaches 4.5 V, and then charging the battery at a constant voltage of 4.5 V until the current tapers off to 0.02C. Subsequently, leaving the lithium-ion battery to stand for 5 minutes in a test chamber ventilated with air at a temperature of 25° C. and a humidity of 80%, and then heating the test chamber to 130° C. at a rate of 5° C./min. Keeping the temperature constant at 130° C. for 10 minutes, and then checking whether the lithium-ion battery catches fire or explodes. Determining that the battery passes the test if the battery does not catch fire or explode. Testing 10 batteries for each embodiment and comparative embodiment. Calculating the 130° C. hot-oven test pass rate as: hot-oven test pass rate=number of batteries passing the 130° C. hot-oven test/10.

Charging a lithium-ion battery at 25° C. at a constant current of 2C until the voltage reaches 4.5 V, and then charging the battery at a constant voltage of 4.5 V until the current tapers off to 0.02C. Subsequently, leaving the lithium-ion battery to stand for 5 minutes in a test chamber ventilated with air at a temperature of 25° C. and a humidity of 80%, and then heating the test chamber to 132° C. at a rate of 5° C./min. Keeping the temperature constant at 132° C. for 10 minutes, and then checking whether the lithium-ion battery catches fire or explodes. Determining that the battery passes the test if the battery does not catch fire or explode. Testing 5 batteries for each embodiment and comparative embodiment. Calculating the 132° C. hot-oven test pass rate as: hot-oven test pass rate=number of batteries passing the 132° C. hot-oven test/10.

The thermal abuse resistance of the lithium-ion battery is represented by the hot-oven test pass rate. The higher the hot-oven test pass rate, the higher the thermal abuse resistance of the lithium-ion battery.

### Testing the Cycle Performance

Charging a lithium-ion battery at a constant current of 2C at 25° C. until the voltage reaches 4.5 V, and then charging the battery at a constant voltage of 4.5 V until the current tapers off to 0.02 C. Leaving the battery to stand for 5 minutes, and then discharging the battery at a constant current of 0.7C until the voltage drops to 3.0 V, thereby completing a first cycle. Recording the discharge capacity at this time. Charging and discharging the lithium-ion battery according to the above process until completion of 1000 cycles (cls). Calculating the capacity retention rate as a metric of the cycle performance of the lithium-ion battery.

Calculating the capacity retention rate as: capacity retention rate (%)=(1000^{th}-cycle discharge capacity/first-cycle discharge capacity)×100%.

The higher the capacity retention rate, the higher the cycle performance of the lithium-ion battery.

### Testing the Expansion Resistance

Leaving a lithium-ion battery in each embodiment and comparative embodiment to stand in a 25° C. thermostat for 30 minutes so that the lithium-ion battery reaches a constant temperature. Measuring the thickness of the lithium-ion battery at the center of the lithium-ion battery, and recording the thickness as an initial thickness. Charging the battery at a constant current of 0.5C until the voltage reaches 4.3 V, and then charging the battery at a constant voltage of 4.3 V until the current tapers off to 0.025C. Leaving the battery to stand for 5 minutes, and then discharging the battery at a constant current of 0.5C until the voltage drops to 3.0 V, thereby completing one cycle. Repeating the above charge and discharge steps for 800 cycles, and then measuring the thickness of the lithium-ion battery at the center of the battery, denoted as an 800^{th} cycle thickness of the battery. Calculating the thickness expansion rate (%) of the lithium-ion battery as: thickness expansion rate=(800th-cycle thickness−initial thickness)/initial thickness×100%.

The expansion resistance of the lithium-ion battery is characterized by the thickness expansion rate. The lower the thickness expansion rate, the higher the expansion resistance of the lithium-ion battery.

### Embodiment 1-1

### Preparing a First Separator

Using a second base film (model: 2325, manufactured by Celgard) as a material of the first separator, where the second base film is made of polyethylene and polypropylene (at a mass ratio of 1:1) and is 7 μm thick.

Mixing poly(vinylidene fluoride-co-hexafluoropropylene copolymer) (PVDF-HFP, with weight-average molecular weight Mw=8.5×10⁶) as a first binder and sodium carboxymethyl cellulose (Mw=8×10⁵) as a first thickener at a mass ratio of 98.5:1.5, adding deionized water as a solvent, and stirring well to form a first bonding layer slurry in which the solid content is 75 wt %.

Mixing aluminum oxide (Al₂O₃) as first ceramic particles and styrene-butadiene rubber (Mw=7×10⁶) as a first ceramic coating binder, adding deionized water as a solvent, and stirring well to form a first ceramic coating slurry in which the solid content is 30 wt %.

Applying the first ceramic coating slurry onto one surface of a first base film, oven-drying the slurry at 60° C. to form a first ceramic coating on one surface of the first base film, applying the first bonding layer slurry onto a surface of the first ceramic coating on a side away from the first base film, oven-drying the slurry at 60° C. to obtain a first separator coated with the first ceramic coating and the first bonding layer on one side. Subsequently, repeating the above steps on the other surface of the first base film to obtain a first separator. The thickness of the first separator is T₁₀=13 μm, the thickness of the first ceramic coating is T₁₃=2.0 μm, the thickness of the first bonding layer is T₁₂=1.0 μm, and the average particle diameter of the first ceramic particles is 1.0 μm. Based on the mass of the first ceramic coating, the mass percent of the first ceramic particles is W₁₁=30%, and the mass percent of the first ceramic coating binder is W₁₂=70%.

### Preparing a Second Separator

Using a second base film (model: 2325, manufactured by Celgard) as a material of the first separator, where the second base film is made of polyethylene and polypropylene (at a mass ratio of 1:1) and is 7 μm thick.

Mixing polyimide (PI, with weight-average molecular weight Mw=6×10⁵) as a second binder and sodium carboxymethyl cellulose (Mw=8×10⁵) as a second thickener at a mass ratio of 98.5:1.5, adding deionized water as a solvent, and stirring well to form a second bonding layer slurry in which the solid content is 75 wt %.

Mixing boehmite (γ-AlOOH) as second ceramic particles and styrene-butadiene rubber (Mw=7×10⁶) as a second ceramic coating binder, adding deionized water as a solvent, and stirring well to form a second ceramic coating slurry in which the solid content is 40 wt %.

Applying the second ceramic coating slurry onto one surface of a second base film, oven-drying the slurry at 60° C. to form a second ceramic coating on one surface of the second base film, applying the second bonding layer slurry onto a surface of the first ceramic coating on a side away from the first base film, oven-drying the slurry at 60° C. to obtain a second separator coated with the second ceramic coating and the second bonding layer on one side. Subsequently, applying the second bonding layer slurry onto the other surface of the second base film, and oven-drying the slurry at 60° C. to obtain a second separator. The thickness of the second separator is T₂₀=11 μm, the thickness of the second ceramic coating is T₂₃=2.0 μm, the thickness of the second bonding layer is T₂₂=1.0 μm, and the average particle diameter of the second ceramic particles is 0.5 μm. Based on the mass of the second ceramic coating, the mass percent of the second ceramic particles is W₂₁=30%, and the mass percent of the second ceramic coating binder is W₂₂=70%.

### Preparing a Negative Electrode Plate

Mixing artificial graphite as a negative active material, styrene-butadiene rubber, and sodium carboxymethyl cellulose at a mass ratio of 97.0:1.5:1.5, adding deionized water as a solvent, and stirring well to obtain a first negative electrode slurry in which the solid content is 75 wt %. At the same time, the first negative electrode slurry also serves as a second negative electrode slurry. Applying the first negative electrode slurry onto one surface of a 6 μm-thick negative current collector copper foil, and oven-drying the slurry at 90° C. to form a 50 μm-thick first negative electrode material layer. Applying the second negative electrode slurry onto the other surface of the negative current collector copper foil, and oven-drying the slurry at 90° C. to form a 50 μm-thick second negative electrode material layer, and therefore, obtain a 106 μm-thick negative electrode plate. Cold-pressing and then cutting the coated negative electrode plate into sheets of 64 mm×817 mm in size for future use. The compaction density of the first negative electrode material layer is 1.725 g/cm³, and the length of the first negative electrode material layer is 710 mm. The compaction density of the second negative electrode material layer is 1.725 g/cm³, and the length of the second negative electrode material layer is 670 mm.

### Preparing a Positive Electrode Plate

Mixing lithium cobalt oxide as a positive active material, conductive carbon black as a conductive agent, and polyvinylidene difluoride (PVDF) as a positive electrode binder at a mass ratio of 97:1.5:1.5, and then adding N-methyl pyrrolidone (NMP) as a solvent, stirring well to obtain a positive electrode slurry in which the solid content is 75 wt %. Applying the positive electrode slurry evenly onto one surface of a m-thick positive current collector aluminum foil, and oven-drying the slurry at 90° C. to form a 55 μm-thick positive electrode material layer. Applying the positive electrode slurry onto the other surface of the positive current collector aluminum foil, and oven-drying the slurry at 90° C. to form a 55 μm-thick positive electrode material layer, and therefore, obtain a 120 μm-thick positive electrode plate coated with the positive electrode material layer on both sides. Cold-pressing and then cutting the coated positive electrode plate into sheets of 60 mm×796 mm in size for future use. The compaction density of the positive electrode material layer is uniformly 4.23 g/cm³.

### Preparing an Electrolyte Solution

Mixing propylene carbonate (PC), diethyl carbonate (DEC), and ethylene carbonate (EC) at a mass ratio of 1:1:1 in a dry argon atmosphere glovebox to form a base solvent, and then adding hexafluorophosphate (LiPF₆) as a lithium salt into the base solvent to dissolve, and stirring well to obtain an electrolyte solution. Based on the mass of the electrolyte solution, the mass percent of LiPF₆ is 14%, and the remainder is the base solvent.

### Preparing a Lithium-Ion Battery

Stacking the above-prepared positive electrode plate, second separator, negative electrode plate, and first separator in sequence, and then winding the stacked structure to obtain an electrode assembly. Leading out a positive tab by spot-welding the aluminum foil, and leading out a negative tab by spot-welding the nickel foil. The second ceramic coating in the second separator faces away from the negative electrode plate, and is opposite to the positive electrode plate. The first separator is disposed on a side, at which the first negative electrode material layer is located, of the negative electrode plate. The second separator is disposed on a side, at which the second negative electrode material layer is located, of the negative electrode plate (the structure is shown in FIG. 2, but is not limited to the example shown in FIG. 2). Putting the electrode assembly into an aluminum laminated film, leaving the electrode assembly in an 80° C. vacuum oven for 12 hours to remove moisture, and then injecting an electrolyte solution to form a cell. Performing vacuum sealing, standing, chemical formation (charging the cell at a constant current of 0.02C until the voltage reaches 3.5 V, and then charging the cell at a constant current of 0.1C until the voltage reaches 3.9 V), capacity grading, and shaping to obtain a lithium-ion battery.

### Embodiment 1-2

The operations are identical to those in Embodiment 1-1 except that, in <Preparing a lithium-ion battery>, the second separator is disposed on a side, at which the first negative electrode material layer is located, of the negative electrode plate; and the first separator is disposed on a side, at which the second negative electrode material layer is located, of the negative electrode plate (the structure is shown in FIG. 5, but is not limited to the example shown in FIG. 5).

### Embodiment 1-3

### Preparing a First Separator

Applying the first ceramic coating slurry onto one surface of a first base film, oven-drying the slurry at 60° C. to form a first ceramic coating on one surface of the first base film, applying the first bonding layer slurry onto a surface of the first ceramic coating on a side away from the first base film, oven-drying the slurry at 60° C. to obtain a first separator coated with the first ceramic coating and the first bonding layer on one side. Subsequently, applying the first bonding layer slurry onto the other surface of the first base film, and oven-drying the slurry at 60° C. to obtain a first separator.

### Preparing a Lithium-Ion Battery

Stacking the above-prepared positive electrode plate, second separator, negative electrode plate, and first separator in sequence, and then winding the stacked structure to obtain an electrode assembly. Leading out a positive tab by spot-welding the aluminum foil, and leading out a negative tab by spot-welding the nickel foil. The second ceramic coating in the second separator faces away from the negative electrode plate, and is opposite to the positive electrode plate. The first ceramic coating in the first separator faces away from the negative electrode plate. The first separator is disposed on a side, at which the first negative electrode material layer is located, of the negative electrode plate. The second separator is disposed on a side, at which the second negative electrode material layer is located, of the negative electrode plate. Putting the electrode assembly into an aluminum laminated film, leaving the electrode assembly in an 80° C. vacuum oven for 12 hours to remove moisture, and then injecting an electrolyte solution to form a cell. Performing vacuum sealing, standing, chemical formation (charging the cell at a constant current of 0.02C until the voltage reaches 3.5 V, and then charging the cell at a constant current of 0.1C until the voltage reaches 3.9 V), capacity grading, and shaping to obtain a lithium-ion battery.

The rest is the same as that in Embodiment 1-1.

### Embodiment 1-4

### Preparing a Second Separator

Applying the second ceramic coating slurry onto one surface of a second base film, oven-drying the slurry at 60° C. to form a second ceramic coating on one surface of the second base film, applying the second bonding layer slurry onto a surface of the first ceramic coating on a side away from the first base film, oven-drying the slurry at 60° C. to obtain a second separator coated with the second ceramic coating and the second bonding layer on one side. Subsequently, repeating the above steps on the other surface of the second base film to obtain a second separator.

### Preparing a Lithium-Ion Battery

Stacking the above-prepared positive electrode plate, second separator, negative electrode plate, and first separator in sequence, and then winding the stacked structure to obtain an electrode assembly. Leading out a positive tab by spot-welding the aluminum foil, and leading out a negative tab by spot-welding the nickel foil. The first separator is disposed on a side, at which the first negative electrode material layer is located, of the negative electrode plate. The second separator is disposed on a side, at which the second negative electrode material layer is located, of the negative electrode plate. Putting the electrode assembly into an aluminum laminated film, leaving the electrode assembly in an 80° C. vacuum oven for 12 hours to remove moisture, and then injecting an electrolyte solution to form a cell. Performing vacuum sealing, standing, chemical formation (charging the cell at a constant current of 0.02C until the voltage reaches 3.5 V, and then charging the cell at a constant current of 0.1C until the voltage reaches 3.9 V), capacity grading, and shaping to obtain a lithium-ion battery.

The rest is the same as that in Embodiment 1-1.

### Embodiments 1-5 to 1-12

Identical to Embodiment 1-1 except that the relevant preparation parameters are adjusted according to Table 1.

### Embodiments 2-1 to 2-10

Identical to Embodiment 1-1 except that the relevant preparation parameters are adjusted according to Table 3.

### Embodiments 3-1 to 3-8

Identical to Embodiment 1-1 except that the relevant preparation parameters are adjusted according to Table 4.

When the mass percent W₁₁ of the first ceramic particles changes, the mass percent W₁₂ of the first ceramic coating binder changes accordingly. The sum of the aggregate mass percent of the first ceramic particles and the first ceramic coating binder is 100%. When the mass percent W₂₁ of the second ceramic particles changes, the mass percent W₂₂ of the second ceramic coating binder changes accordingly. The aggregate mass percent of the second ceramic particles and the second ceramic coating binder is 100%.

### Embodiments 4-1 to 4-16

Identical to Embodiment 2-9 except that the relevant preparation parameters are adjusted according to Table 5.

### Comparative Embodiment 1

Identical to Embodiment 1-1 except that no second separator is disposed and the lithium-ion battery is prepared by the following method:

### Preparing a Lithium-Ion Battery

Stacking the above-prepared positive electrode plate, first separator, negative electrode plate, and first separator in sequence, and then winding the stacked structure to obtain an electrode assembly. Leading out a positive tab by spot-welding the aluminum foil, and leading out a negative tab by spot-welding the nickel foil. Putting the electrode assembly into an aluminum laminated film, leaving the electrode assembly in an 80° C. vacuum oven for 12 hours to remove moisture, and then injecting an electrolyte solution to form a cell. Performing vacuum sealing, standing, chemical formation (charging the cell at a constant current of 0.02C until the voltage reaches 3.5 V, and then charging the cell at a constant current of 0.1C until the voltage reaches 3.9 V), capacity grading, and shaping to obtain a lithium-ion battery.

### Comparative Embodiment 2

Identical to Embodiment 1-1 except that no first separator is disposed and the lithium-ion battery is prepared by the following method:

### Preparing a Lithium-Ion Battery

Stacking the above-prepared positive electrode plate, second separator, negative electrode plate, and second separator in sequence, and then winding the stacked structure to obtain an electrode assembly. Leading out a positive tab by spot-welding the aluminum foil, and leading out a negative tab by spot-welding the nickel foil. The second ceramic coating in the second separator faces away from the negative electrode plate. Putting the electrode assembly into an aluminum laminated film, leaving the electrode assembly in an 80° C. vacuum oven for 12 hours to remove moisture, and then injecting an electrolyte solution to form a cell. Performing vacuum sealing, standing, chemical formation (charging the cell at a constant current of 0.02C until the voltage reaches 3.5 V, and then charging the cell at a constant current of 0.1C until the voltage reaches 3.9 V), capacity grading, and shaping to obtain a lithium-ion battery.

The rest is the same as that in Embodiment 1-1.

### Comparative Embodiment 3

Identical to Embodiment 1-1 except that the relevant preparation parameters are adjusted according to Table 1.

Table 1 to Table 5 show the preparation parameters and performance parameters of each embodiment and each comparative embodiment.

TABLE 1

| | Number | Number | | | | | Materials of |
|---|---|---|---|---|---|---|---|
| | of layers | of layers | | Type of | | | first base |
| | of first | of second | Positional relation between | first | Type of | Type of | film and |
| | ceramic | ceramic | separator and negative | ceramic | first | second | second base |
| | coating | coating | electrode plate | particles | binder | binder | film |
| Embodiment | Double | Single | The first separator is | Aluminum | PVDF-HFP | PI | PP + PE |
| 1-1 | layer | layer | disposed on a side at which | oxide | | | (at a mass |
| | | | the first negative electrode | | | | ratio of 1:1) |
| | | | material layer is located, and | | | | |
| | | | the second separator is | | | | |
| | | | disposed on a side at which | | | | |
| | | | the second negative electrode | | | | |
| | | | material layer is located | | | | |
| Embodiment | Double | Single | The second separator is | Aluminum | PVDF-HFP | PI | PP + PE |
| 1-2 | layer | layer | disposed on a side at which | oxide | | | (at a mass |
| | | | the first negative electrode | | | | ratio of 1:1) |
| | | | material layer is located, and | | | | |
| | | | the first separator is disposed | | | | |
| | | | on a side at which the second | | | | |
| | | | negative electrode material | | | | |
| | | | layer is located | | | | |
| Embodiment | Single | Single | The first separator is | Aluminum | PVDF-HFP | PI | PP + PE |
| 1-3 | layer | layer | disposed on a side at which | oxide | | | (at a mass |
| | | | the first negative electrode | | | | ratio of 1:1) |
| | | | material layer is located, and | | | | |
| | | | the second separator is | | | | |
| | | | disposed on a side at which | | | | |
| | | | the second negative electrode | | | | |
| | | | material layer is located | | | | |
| Embodiment | Double | Double | The first separator is | Aluminum | PVDF-HFP | PI | PP + PE |
| 1-4 | layer | layer | disposed on a side at which | oxide | | | (at a mass |
| | | | the first negative electrode | | | | ratio of 1:1) |
| | | | material layer is located, and | | | | |
| | | | the second separator is | | | | |
| | | | disposed on a side at which | | | | |
| | | | the second negative electrode | | | | |
| | | | material layer is located | | | | |
| Embodiment | Double | Single | The first separator is | Zirconium | PVDF-HFP | PI | PP + PE |
| 1-5 | layer | layer | disposed on a side at which | dioxide | | | (at a mass |
| | | | the first negative electrode | | | | ratio of 1:1) |
| | | | material layer is located, and | | | | |
| | | | the second separator is | | | | |
| | | | disposed on a side at which | | | | |
| | | | the second negative electrode | | | | |
| | | | material layer is located | | | | |
| Embodiment | Double | Single | The first separator is | Silicon | PVDF-HFP | PI | PP + PE |
| 1-6 | layer | layer | disposed on a side at which | dioxide | | | (at a mass |
| | | | the first negative electrode | | | | ratio of 1:1) |
| | | | material layer is located, and | | | | |
| | | | the second separator is | | | | |
| | | | disposed on a side at which | | | | |
| | | | the second negative electrode | | | | |
| | | | material layer is located | | | | |
| Embodiment | Double | Single | The first separator is | Titanium | PVDF-HFP | PI | PP + PE |
| 1-7 | layer | layer | disposed on a side at which | dioxide | | | (at a mass |
| | | | the first negative electrode | | | | ratio of 1:1) |
| | | | material layer is located, and | | | | |
| | | | the second separator is | | | | |
| | | | disposed on a side at which | | | | |
| | | | the second negative electrode | | | | |
| | | | material layer is located | | | | |
| Embodiment | Double | Single | The first separator is | Aluminum | PVDF (Mw = | PI | PP + PE |
| 1-8 | layer | layer | disposed on a side at which | oxide | 7.0 × 10⁶) | | (at a mass |
| | | | the first negative electrode | | | | ratio of 1:1) |
| | | | material layer is located, and | | | | |
| | | | the second separator is | | | | |
| | | | disposed on a side at which | | | | |
| | | | the second negative electrode | | | | |
| | | | material layer is located | | | | |
| Embodiment | Double | Single | The first separator is | Aluminum | PVDF-HFP | Polyvinyl | PP + PE |
| 1-9 | layer | layer | disposed on a side at which | oxide | | alcohol | (at a mass |
| | | | the first negative electrode | | | (Mw = | ratio of 1:1) |
| | | | material layer is located, and | | | 2 × 10⁶) | |
| | | | the second separator is | | | | |
| | | | disposed on a side at which | | | | |
| | | | the second negative electrode | | | | |
| | | | material layer is located | | | | |
| Embodiment | Double | Single | The first separator is | Aluminum | PVDF-HFP | PI | PP (Mw = |
| 1-10 | layer | layer | disposed on a side at which | oxide | | | 7 × 10⁶) |
| | | | the first negative electrode | | | | |
| | | | material layer is located, and | | | | |
| | | | the second separator is | | | | |
| | | | disposed on a side at which | | | | |
| | | | the second negative electrode | | | | |
| | | | material layer is located | | | | |
| Embodiment | Double | Single | The first separator is | Aluminum | PVDF-HFP | PI | PET (Mw = |
| 1-11 | layer | layer | disposed on a side at which | oxide | | | 6 × 10⁶) |
| | | | the first negative electrode | | | | |
| | | | material layer is located, and | | | | |
| | | | the second separator is | | | | |
| | | | disposed on a side at which | | | | |
| | | | the second negative electrode | | | | |
| | | | material layer is located | | | | |
| Embodiment | Double | Single | The first separator is | Aluminum | PVDF-HFP | CMC-Na | PP + PE |
| 1-12 | layer | layer | disposed on a side at which | oxide | | (Mw = | (at a mass |
| | | | the first negative electrode | | | 6 × 10⁷) | ratio of 1:1) |
| | | | material layer is located, and | | | | |
| | | | the second separator is | | | | |
| | | | disposed on a side at which | | | | |
| | | | the second negative electrode | | | | |
| | | | material layer is located | | | | |
| Comparative | Double | \ | \ | Aluminum | PVDF-HFP | \ | PP + PE |
| Embodiment 1 | layer | | | oxide | | | (at a mass |
| | | | | | | | ratio of 1:1) |
| Comparative | \ | Single | \ | \ | \ | PI | PP + PE |
| Embodiment 2 | | layer | | | | | (at a mass |
| | | | | | | | ratio of 1:1) |
| Comparative | Double | Single | The first separator is | Aluminum | CMC-Na | Styrene- | PP + PE |
| Embodiment 3 | layer | layer | disposed on a side at which | oxide | (Mw = | butadiene | (at a mass |
| | | | the first negative electrode | | 6 × 10⁷) | rubber | ratio of 1:1) |
| | | | material layer is located, and | | | (SBR, Mw = | |
| | | | the second separator is | | | 3 × 10⁶) | |
| | | | disposed on a side at which | | | | |
| | | | the second negative electrode | | | | |
| | | | material layer is located | | | | |

Note:
“\” in Table 1 indicates absence of the corresponding parameter.

TABLE 2

| | | | | Capacity | Thickness | 130° C. | 132° C. |
|---|---|---|---|---|---|---|---|
| | F₁ | F₂ | F₃ | retention | expansion | hot-oven test | hot-oven test |
| | (N/m) | (N/m) | (N/m) | rate (%) | rate (%) | pass rate | pass rate |
| Embodiment 1-1 | 10.1 | 8.1 | 17.1 | 90.26 | 8.5 | 10/10 | 10/10 |
| Embodiment 1-2 | 10.2 | 8.3 | 17.2 | 86.89 | 8.6 | 10/10 | 10/10 |
| Embodiment 1-3 | 10.0 | 8.2 | 17.4 | 88.34 | 8.4 | 10/10 | 10/10 |
| Embodiment 1-4 | 10.3 | 8.3 | 17.1 | 91.45 | 8.7 | 10/10 | 10/10 |
| Embodiment 1-5 | 10.2 | 8.0 | 17.4 | 88.55 | 8.6 | 10/10 | 10/10 |
| Embodiment 1-6 | 10.1 | 8.5 | 17.2 | 87.23 | 8.5 | 9/10 | 6/10 |
| Embodiment 1-7 | 10.3 | 8.1 | 17.2 | 86.23 | 8.5 | 10/10 | 7/10 |
| Embodiment 1-8 | 9.1 | 8.2 | 17.1 | 89.46 | 8.6 | 10/10 | 8/10 |
| Embodiment 1-9 | 10.3 | 7.6 | 16.2 | 88.89 | 9.5 | 10/10 | 7/10 |
| Embodiment 1-10 | 10.4 | 8.2 | 17.3 | 90.11 | 8.7 | 10/10 | 10/10 |
| Embodiment 1-11 | 10.3 | 8.1 | 17.0 | 89.49 | 8.8 | 10/10 | 10/10 |
| Embodiment 1-12 | 10.3 | 7.8 | 16.5 | 87.89 | 9.9 | 9/10 | 5/10 |
| Comparative | 10.1 | 6.8 | 10.2 | 92.55 | 7.7 | 3/10 | 0/10 |
| Embodiment 1 | | | | | | | |
| Comparative | 17.4 | 9.3 | 17.2 | 77.23 | 8.6 | 10/10 | 10/10 |
| Embodiment 2 | | | | | | | |
| Comparative | 6.8 | 6.7 | 16.2 | 78.26 | 17.6 | 5/10 | 0/10 |
| Embodiment 3 | | | | | | | |

As can be seen from Embodiments 1-1 to 1-9, Embodiments 1-12, and Comparative Embodiments 1 to 3, the secondary battery according to an embodiment of this application uses a first separator and a second separator of different types in combination, and controls the types of the first ceramic particles and the first binder in the first separator as well as the types of the second ceramic particles and the second binder in the second separator to fall within the ranges specified herein. In this way, the first separator is of relatively strong adhesion F₁ to the negative electrode plate, and the second separator is of relatively high adhesion F₂ and F₃ to the positive electrode plate and the negative electrode plate. The secondary battery also exhibits a relatively high capacity retention rate, a relatively low thickness expansion rate, and a relatively high hot-oven test pass rate at both 130° C. and 132° C. simultaneously, indicating that the lithium-ion battery of this application achieves a desirable level of cycle performance, expansion resistance, and thermal abuse resistance simultaneously. By contrast, the secondary batteries in Comparative Embodiments 1 to 3 employs the same type of separator, or in other words, the types of the ceramic particles and binder in the two separators fail to meet the requirements specified herein. Therefore, in the comparative embodiments, the separator is of lower adhesion to the positive electrode plate and the negative electrode plate. The secondary batteries in the comparative embodiments fail to exhibit a higher capacity retention rate, a lower thickness expansion rate, and a higher hot-oven test pass rate at both 130° C. and 132° C. simultaneously, indicating that the secondary batteries in the comparative embodiments can hardly achieve a high level of cycle performance, expansion resistance, and thermal abuse resistance simultaneously. As can be seen from Embodiment 1-1 versus Embodiments 1-5 to 1-8, the first binder in the first separator is PVDF-HFP, and the first ceramic particles are aluminum trioxide (aluminum oxide), thereby contributing to the best overall performance. As can be seen from Embodiment 1-1 versus Embodiments 1-9 and 1-12, the second binder in the second separator is PI, and the second ceramic particles are boehmite, thereby contributing to the best overall performance.

The materials of the first base film and the second base film usually affect the cycle performance, expansion resistance, and thermal abuse resistance of the secondary battery. As can be seen from Embodiments 1-1, 1-10, and 1-11, the secondary battery containing a first base film and a second base film made of materials falling within the ranges specified herein exhibits a higher capacity retention rate, a lower thickness expansion rate, and a higher hot-oven test pass rate at both 130° C. and 132° C. simultaneously, indicating that the secondary battery achieves a desirable level of cycle performance, expansion resistance, and thermal abuse resistance simultaneously.

TABLE 3

| | Average | Average | | | | |
|---|---|---|---|---|---|---|
| | particle | particle | Capacity | Thickness | 130° C. | 132° C. |
| | diameter of | diameter of | retention | expansion | hot-oven | hot-oven |
| | first ceramic | second ceramic | rate | rate | test pass | test pass |
| | particles (μm) | particles (μm) | (%) | (%) | rate | rate |
| Embodiment 1-1 | 1.0 | 0.5 | 90.26 | 8.5 | 10/10 | 10/10 |
| Embodiment 2-1 | 0.2 | 0.5 | 90.06 | 8.6 | 10/10 | 10/10 |
| Embodiment 2-2 | 1.2 | 0.5 | 90.13 | 8.5 | 10/10 | 10/10 |
| Embodiment 2-3 | 0.1 | 0.5 | 85.23 | 8.7 | 10/10 | 10/10 |
| Embodiment 2-4 | 1.9 | 0.5 | 90.32 | 8.4 | 10/10 | 6/10 |
| Embodiment 2-5 | 1.0 | 0.1 | 90.15 | 8.5 | 10/10 | 10/10 |
| Embodiment 2-6 | 1.0 | 1.0 | 89.98 | 8.5 | 10/10 | 10/10 |
| Embodiment 2-7 | 1.0 | 0.05 | 86.33 | 8.3 | 10/10 | 7/10 |
| Embodiment 2-8 | 1.0 | 1.2 | 89.15 | 8.6 | 9/10 | 5/10 |
| Embodiment 2-9 | 0.2 | 0.1 | 88.67 | 8.7 | 10/10 | 10/10 |
| Embodiment 2-10 | 1.2 | 1.0 | 90.99 | 8.5 | 10/10 | 10/10 |

The average particle diameter of the first ceramic particles usually affects the cycle performance, expansion resistance, and thermal abuse resistance of the secondary battery. As can be seen from Embodiment 1-1, Embodiments 2-1 to 2-4, and Embodiments 2-9 and 2-10, the secondary battery containing the first ceramic particles with an average particle diameter falling within the range specified herein exhibits a higher capacity retention rate, a lower thickness expansion rate, and a higher hot-oven test pass rate at both 130° C. and 132° C. simultaneously, indicating that the secondary battery achieves a desirable level of cycle performance, expansion resistance, and thermal abuse resistance simultaneously. In contrast to Embodiments 1-1, 2-1, and 2-2, the first ceramic particles in Embodiment 2-3 are of a smaller average particle diameter, and therefore, are less capable of retaining the electrolyte solution and improving the cycle performance of the secondary battery. The first ceramic particles in Embodiment 2-4 are of a larger average particle diameter, and therefore, are more prone to pierce the separator and cause a short circuit in the hot-oven test, and exhibit a lower thermal abuse resistance.

The average particle diameter of the second ceramic particles usually affects the cycle performance, expansion resistance, and safety performance of the secondary battery. As can be seen from Embodiment 1-1, Embodiments 2-5 to 2-8, and Embodiments 2-9 and 2-10, the secondary battery containing the second ceramic particles with an average particle diameter falling within the range specified herein exhibits a higher capacity retention rate, a lower thickness expansion rate, and a higher hot-oven test pass rate at both 130° C. and 132° C. simultaneously, indicating that the secondary battery achieves a desirable level of cycle performance, expansion resistance, and thermal abuse resistance simultaneously. In contrast to Embodiments 1-1, 2-5, and 2-6, the second ceramic particles in Embodiment 2-7 are of a smaller average particle diameter, and therefore, are less capable of retaining the electrolyte solution and improving the cycle performance of the secondary battery. The second ceramic particles in Embodiment 2-8 are of a larger average particle diameter, and therefore, are more prone to pierce the separator and cause a short circuit in the hot-oven test, and exhibit a lower thermal abuse resistance.

TABLE 4

| | | | | | 130° C. | 132° C. |
|---|---|---|---|---|---|---|
| | | | Capacity | Thickness | hot-oven | hot-oven |
| | W₁₁ | W₂₁ | retention | expansion | test | test |
| | (%) | (%) | rate (%) | rate (%) | pass rate | pass rate |
| Embodiment 1-1 | 30 | 30 | 90.26 | 8.5 | 10/10 | 10/10 |
| Embodiment 3-1 | 10 | 30 | 90.12 | 8.3 | 10/10 | 10/10 |
| Embodiment 3-2 | 50 | 30 | 90.20 | 8.7 | 10/10 | 10/10 |
| Embodiment 3-3 | 5 | 30 | 85.33 | 8.6 | 9/10 | 5/10 |
| Embodiment 3-4 | 55 | 30 | 91.42 | 8.2 | 10/10 | 3/10 |
| Embodiment 3-5 | 30 | 10 | 90.05 | 8.6 | 10/10 | 10/10 |
| Embodiment 3-6 | 30 | 50 | 89.78 | 8.6 | 10/10 | 10/10 |
| Embodiment 3-7 | 30 | 5 | 86.54 | 8.7 | 9/10 | 6/10 |
| Embodiment 3-8 | 30 | 55 | 89.45 | 8.4 | 10/10 | 7/10 |

The mass percent W₁₁ of the first ceramic particles usually affects the cycle performance, expansion resistance, and safety performance of the secondary battery. As can be seen from Embodiment 1-1 and Embodiments 3-1 to 3-4, the secondary battery containing the first ceramic particles with a mass percent W₁₁ falling within the range specified herein exhibits a higher capacity retention rate, a lower thickness expansion rate, and a higher hot-oven test pass rate at both 130° C. and 132° C. simultaneously, indicating that the secondary battery achieves a desirable level of cycle performance, expansion resistance, and thermal abuse resistance simultaneously. In contrast to Embodiments 1-1, 3-1, and 3-2, in Embodiment 3-3, the mass percent of the first ceramic particles in the first ceramic coating is lower, and therefore, the first ceramic particles are less capable of retaining the electrolyte solution and binding the first base film at high temperature, and improve the cycle performance and thermal abuse resistance of the secondary battery to a lesser extent. In Embodiment 3-4, the mass percent of the first ceramic particles in the first ceramic coating is higher, and therefore, the first ceramic particles are more prone to pierce the separator and cause a short circuit in the hot-oven test, and exhibit a lower thermal abuse resistance.

The mass percent W₂₁ of the second ceramic particles usually affects the cycle performance, expansion resistance, and safety performance of the secondary battery. As can be seen from Embodiment 1-1 and Embodiments 3-5 to 3-8, the secondary battery containing the second ceramic particles with a mass percent W₂₁ falling within the range specified herein exhibits a higher capacity retention rate, a lower thickness expansion rate, and a higher hot-oven test pass rate at both 130° C. and 132° C. simultaneously, indicating that the secondary battery achieves a desirable level of cycle performance, expansion resistance, and thermal abuse resistance simultaneously. In contrast to Embodiments 1-1, 3-5, and 3-6, in Embodiment 3-7, the mass percent of the second ceramic particles in the second ceramic coating is lower, and therefore, the second ceramic particles are less capable of retaining the electrolyte solution and binding the second base film at high temperature, and improve the cycle performance and thermal abuse resistance of the secondary battery to a lesser extent. In Embodiment 3-8, the mass percent of the second ceramic particles in the second ceramic coating is higher, and therefore, the second ceramic particles are more prone to pierce the separator and cause a short circuit in the hot-oven test, and exhibit a lower thermal abuse resistance.

TABLE 5

| | | | | | | | | Capacity | Thickness | 130° C. | 132° C. |
|---|---|---|---|---|---|---|---|---|---|---|---|
| | | | | | | | | retention | expansion | hot-oven | hot-oven |
| | T₁₃ | T₁₂ | T₂₃ | T₂₂ | F₁ | F₂ | F₃ | rate | rate | test pass | test pass |
| | (μm) | (μm) | (μm) | (μm) | (N/m) | (N/m) | (N/m) | (%) | (%) | rate | rate |
| Embodiment | 2.0 | 1.0 | 2.0 | 1.0 | 10.2 | 8.1 | 17.2 | 88.67 | 8.7 | 10/10 | 10/10 |
| 2-9 | | | | | | | | | | | |
| Embodiment | 0.5 | 1.0 | 2.0 | 1.0 | 10.3 | 8.3 | 17.5 | 86.12 | 8.6 | 10/10 | 9/10 |
| 4-1 | | | | | | | | | | | |
| Embodiment | 2.5 | 1.0 | 2.0 | 1.0 | 10.2 | 8.3 | 17.2 | 91.26 | 8.7 | 10/10 | 10/10 |
| 4-2 | | | | | | | | | | | |
| Embodiment | 0.2 | 1.0 | 2.0 | 1.0 | 10.4 | 8.5 | 17.5 | 84.23 | 8.4 | 9/10 | 5/10 |
| 4-3 | | | | | | | | | | | |
| Embodiment | 3.0 | 1.0 | 2.0 | 1.0 | 10.6 | 8.3 | 17.4 | 91.34 | 8.2 | 9/10 | 7/10 |
| 4-4 | | | | | | | | | | | |
| Embodiment | 2.0 | 0.2 | 2.0 | 1.0 | 9.6 | 8.3 | 17.4 | 88.34 | 8.9 | 10/10 | 9/10 |
| 4-5 | | | | | | | | | | | |
| Embodiment | 2.0 | 5 | 2.0 | 1.0 | 11.7 | 8.3 | 17.4 | 87.17 | 8.1 | 10/10 | 10/10 |
| 4-6 | | | | | | | | | | | |
| Embodiment | 2.0 | 0.1 | 2.0 | 1.0 | 8.3 | 8.4 | 17.3 | 88.23 | 9.6 | 10/10 | 7/10 |
| 4-7 | | | | | | | | | | | |
| Embodiment | 2.0 | 8.5 | 2.0 | 1.0 | 14.8 | 8.4 | 17.3 | 85.12 | 7.9 | 10/10 | 10/10 |
| 4-8 | | | | | | | | | | | |
| Embodiment | 2.0 | 1.0 | 0.3 | 1.0 | 10.5 | 8.3 | 17.3 | 88.12 | 8.8 | 10/10 | 9/10 |
| 4-9 | | | | | | | | | | | |
| Embodiment | 2.0 | 1.0 | 2.5 | 1.0 | 10.2 | 8.3 | 17.1 | 89.26 | 8.7 | 10/10 | 10/10 |
| 4-10 | | | | | | | | | | | |
| Embodiment | 2.0 | 1.0 | 0.1 | 1.0 | 10.2 | 8.1 | 17.3 | 82.23 | 8.6 | 8/10 | 5/10 |
| 4-11 | | | | | | | | | | | |
| Embodiment | 2.0 | 1.0 | 3.0 | 1.0 | 10.4 | 8.2 | 17.6 | 90.24 | 8.5 | 10/10 | 9/10 |
| 4-12 | | | | | | | | | | | |
| Embodiment | 2.0 | 1.0 | 2.0 | 0.2 | 10.4 | 7.2 | 16.1 | 88.14 | 9.1 | 10/10 | 9/10 |
| 4-13 | | | | | | | | | | | |
| Embodiment | 2.0 | 1.0 | 2.0 | 5.0 | 10.2 | 9.4 | 18.6 | 87.15 | 7.6 | 10/10 | 10/10 |
| 4-14 | | | | | | | | | | | |
| Embodiment | 2.0 | 1.0 | 2.0 | 0.1 | 10.6 | 6.3 | 12.8 | 85.56 | 9.9 | 9/10 | 7/10 |
| 4-15 | | | | | | | | | | | |
| Embodiment | 2.0 | 1.0 | 2.0 | 8.5 | 10.3 | 11.6 | 19.3 | 83.34 | 7.3 | 10/10 | 6/10 |
| 4-16 | | | | | | | | | | | |

The thickness T₁₃ of the first ceramic coating usually affects the cycle performance, expansion resistance, and safety performance of the secondary battery. As can be seen from Embodiment 2-9 and Embodiments 4-1 to 4-4, the secondary battery containing the first ceramic coating of a thickness T₁₃ falling within the range specified herein exhibits a higher capacity retention rate, a lower thickness expansion rate, and a higher hot-oven test pass rate at both 130° C. and 132° C. simultaneously, indicating that the secondary battery achieves a desirable level of cycle performance, expansion resistance, and thermal abuse resistance simultaneously. In contrast to Embodiments 2-9, 4-1, and 4-2, the first ceramic coating in Embodiment 4-3 is thinner, and therefore, is less capable of retaining the electrolyte solution and binding the first base film at high temperature, and improves the cycle performance and thermal abuse resistance of the secondary battery to a lesser extent. In Embodiment 4-4, the first ceramic coating is thicker, and therefore, causes a slight loss to the energy density, and the first ceramic particles are more prone to pierce the separator and cause a short circuit in the hot-oven test, thereby exhibiting a lower thermal abuse resistance.

The thickness T₁₂ of the first bonding layer usually affects the cycle performance, expansion resistance, and safety performance of the secondary battery. As can be seen from Embodiment 1-1 and Embodiments 4-5 to 4-8, the secondary battery containing the first bonding layer of a thickness T₁₂ falling within the range specified herein exhibits a higher capacity retention rate, a lower thickness expansion rate, and a higher hot-oven test pass rate at both 130° C. and 132° C. simultaneously, indicating that the secondary battery achieves a desirable level of cycle performance, expansion resistance, and thermal abuse resistance simultaneously. In contrast to Embodiments 2-9, 4-5, and 4-6, the first bonding layer in Embodiment 4-7 is thinner, and binds the electrode plate less strongly. In addition, the first bonding layer may melt at high temperature, thereby suppressing the shrinkage of the separator to a lesser extent. Therefore, the first bonding layer improves the expansion resistance and thermal abuse resistance of the secondary battery to a lesser extent. In Embodiment 4-8, the first bonding layer is thicker, and therefore, and causes a slight loss to the energy density. The relatively large thickness of the first bonding layer makes the lithium-ion transmission path longer during charge and discharge, so that the first bonding layer improves the cycle performance of the secondary battery to a lesser extent.

The thickness T₂₃ of the second ceramic coating usually affects the cycle performance, energy density, and safety performance of the secondary battery. As can be seen from Embodiment 1-1 and Embodiments 4-9 to 4-12, the secondary battery containing the second ceramic coating of a thickness T₂₃ falling within the range specified herein exhibits a higher capacity retention rate, a lower thickness expansion rate, and a higher hot-oven test pass rate at both 130° C. and 132° C. simultaneously, indicating that the secondary battery achieves a desirable level of cycle performance, expansion resistance, and thermal abuse resistance simultaneously. In contrast to Embodiments 2-9, 4-9, and 4-10, in Embodiment 4-11, the second ceramic coating is thinner, and therefore, the second ceramic coating is less capable of binding the second base film at high temperature, and improves the thermal abuse resistance of the secondary battery to a lesser extent. In Embodiment 4-12, the second ceramic coating is thicker, and therefore, causes a slight loss to the energy density, and the second ceramic particles are more prone to pierce the separator and cause a short circuit in the hot-oven test, and exhibit a lower thermal abuse resistance.

The thickness T₂₂ of the second bonding layer usually affects the cycle performance, expansion resistance, and safety performance of the secondary battery. As can be seen from Embodiment 1-1 and Embodiments 4-13 to 4-16, the secondary battery containing the second bonding layer of a thickness T₂₂ falling within the range specified herein exhibits a higher capacity retention rate, a lower thickness expansion rate, and a higher hot-oven test pass rate at both 130° C. and 132° C. simultaneously, indicating that the secondary battery achieves a desirable level of cycle performance, expansion resistance, and thermal abuse resistance simultaneously. In contrast to Embodiments 2-9, 4-13, and 4-14, the second bonding layer in Embodiment 4-15 is thinner, and binds the electrode plate less strongly. In addition, the second bonding layer suppresses the shrinkage of the separator at high temperature to a lesser extent. Therefore, the second bonding layer improves the expansion resistance and thermal abuse resistance of the secondary battery to a lesser extent. In Embodiment 4-16, the second bonding layer is thicker, and therefore, and causes a slight loss to the energy density. The relatively large thickness of the second bonding layer makes the lithium-ion transmission path longer during charge and discharge, so that the second bonding layer improves the cycle performance of the secondary battery to a lesser extent.

It is hereby noted that the relational terms herein such as “first” and “second” are used merely to differentiate one entity or operation from another, but do not involve or imply any actual relationship or sequence between the entities or operations. Moreover, the terms “include”, “comprise”, and any variation thereof are intended to cover a non-exclusive inclusion relationship by which a process, method, or object that includes or comprises a series of elements not only includes such elements, but also includes other elements not expressly specified or also includes inherent elements of the process, method, or object.

Different embodiments of this application are described in a correlative manner. For the same or similar part in one embodiment, reference may be made to another embodiment. Each embodiment focuses on differences from other embodiments.

What is described above is merely exemplary embodiments of this application, but is not intended to limit this application. Any modifications, equivalent replacements, improvements, and the like made without departing from the spirit and principles of this application still fall within the protection scope of this application.

What is claimed is:

1. A secondary battery, comprising an electrode assembly, wherein the electrode assembly is a jelly-roll structure; the electrode assembly comprises a positive electrode plate, a negative electrode plate, a first separator, and a second separator;
the first separator comprises a first base film, a first bonding layer, and a first ceramic coating; the first bonding layer is disposed on both sides of the first base film;
the first ceramic coating is disposed on at least one side of the first base film and is located between the first base film and the first bonding layer; the first bonding layer comprises a first binder; the first binder comprises at least one of polyvinylidene fluoride or poly(vinylidene fluoride-co-hexafluoropropylene); the first ceramic coating comprises first ceramic particles; and the first ceramic particles comprise at least one of aluminum oxide, zirconium dioxide, titanium dioxide, or silicon dioxide; and
the second separator comprises a second base film, a second bonding layer, and a second ceramic coating; the second bonding layer is disposed on both sides of the second base film; the second ceramic coating is disposed on at least one side of the second base film and is located between the second base film and the second bonding layer; the second bonding layer comprises a second binder; the second binder comprises at least one of polyimide, polyvinyl alcohol, or sodium carboxymethyl cellulose; the second ceramic coating comprises second ceramic particles; and the second ceramic particles comprise boehmite.

2. The secondary battery according to claim 1, wherein the first binder comprises poly(vinylidene fluoride-co-hexafluoropropylene), and the first ceramic particles comprise aluminum oxide; and
the second binder comprises polyimide, and the second ceramic particles comprise boehmite.

3. The secondary battery according to claim 1, wherein the negative electrode plate is located between the first separator and the second separator; the negative electrode plate comprises a negative current collector, a first negative electrode material layer, and a second negative electrode material layer; the first negative electrode material layer and the second negative electrode material layer are disposed on two sides of the negative current collector respectively; along a winding direction of the electrode assembly, a length of the first negative electrode material layer is greater than a length of the second negative electrode material layer; the first separator is disposed on a first side of the negative electrode plate, wherein the first negative electrode material layer is located on the first side of the negative electrode plate; and the second separator is disposed on a second side of the negative electrode plate, wherein the second negative electrode material layer is located on the second side of the negative electrode plate.

4. The secondary battery according to claim 3, wherein the first ceramic coating is disposed on both sides of the first base film.

5. The secondary battery according to claim 3, wherein the second separator is located between the positive electrode plate and the negative electrode plate, and the second ceramic coating is disposed on only one side of the second base film, the one side of the second base film being a side facing away from the negative electrode plate.

6. The secondary battery according to claim 1, wherein an average particle diameter of the first ceramic particles is 0.2 μm to 1.2 μm, and an average particle diameter of the second ceramic particles is 0.1 μm to 1.0 μm.

7. The secondary battery according to claim 1, wherein a thickness of the first ceramic coating is 0.5 μm to 2.5 μm, and a thickness of the second ceramic coating is 0.3 μm to 2.5 μm.

8. The secondary battery according to claim 1, wherein, based on a mass of the first ceramic coating, a mass percentage of the first ceramic particles is 10% to 50%; and, based on a mass of the second ceramic coating, a mass percentage of the second ceramic particles is 10% to 50%.

9. The secondary battery according to claim 1, wherein a thickness of the first bonding layer is 0.2 μm to 5 μm, and a thickness of the second bonding layer is 0.2 μm to 5 μm.

10. The secondary battery according to claim 1, wherein the first base film and the second base film each independently comprise at least one of polyimide, polyamide, polysulfone, polyacrylonitrile, cellulose, polyetheretherketone, polyphenylene sulfide, polyacrylate ester, polyethylene terephthalate, poly(p-benzamide), polyarylethersulfoneketone, aramid fiber, poly(aromatic sulfone) fiber, or polyolefin; and polymerization monomers of the polyolefin comprise at least one of ethylene, propylene, 1-butene, 1-pentene, 1-hexene, 1-octene, 4-methyl-1-pentene, cyclobutene, cyclopentene, or cyclohexene.

11. An electrical device, comprising the secondary battery according to claim 1.

12. The electrical device according to claim 11, wherein the first binder comprises poly(vinylidene fluoride-co-hexafluoropropylene), and the first ceramic particles comprise aluminum oxide; and
the second binder comprises polyimide, and the second ceramic particles comprise boehmite.

13. The electrical device according to claim 11, wherein the negative electrode plate is located between the first separator and the second separator; the negative electrode plate comprises a negative current collector, a first negative electrode material layer and a second negative electrode material layer; the first negative electrode material layer and the second negative electrode material layer are disposed on two sides of the negative current collector respectively; along a winding direction of the electrode assembly, a length of the first negative electrode material layer is greater than a length of the second negative electrode material layer; the first separator is disposed on a first side of the negative electrode plate, wherein the first negative electrode material layer is located on the first side of the negative electrode plate; and the second separator is disposed on a second side of the negative electrode plate, wherein the second negative electrode material layer is located on the second side of the negative electrode plate.

14. The electrical device according to claim 13, wherein the first ceramic coating is disposed on both sides of the first base film.

15. The electrical device according to claim 13, wherein the second separator is located between the positive electrode plate and the negative electrode plate, and the second ceramic coating is disposed on only one side of the second base film, the one side of the second base film being a side facing away from the negative electrode plate.

16. The electrical device according to claim 11, wherein an average particle diameter of the first ceramic particles is 0.2 μm to 1.2 μm, and an average particle diameter of the second ceramic particles is 0.1 μm to 1.0 μm.

17. The electrical device according to claim 11, wherein a thickness of the first ceramic coating is 0.5 μm to 2.5 μm, and a thickness of the second ceramic coating is 0.3 μm to 2.5 μm.

18. The electrical device according to claim 11, wherein, based on a mass of the first ceramic coating, a mass percentage of the first ceramic particles is 10% to 50%; and, based on a mass of the second ceramic coating, a mass percentage of the second ceramic particles is 10% to 50%.

19. The electrical device according to claim 11, wherein a thickness of the first bonding layer is 0.2 μm to 5 μm, and a thickness of the second bonding layer is 0.2 μm to 5 μm.

20. The electrical device according to claim 11, wherein the first base film and the second base film each independently comprise at least one of polyimide, polyamide, polysulfone, polyacrylonitrile, cellulose, polyetheretherketone, polyphenylene sulfide, polyacrylate ester, polyethylene terephthalate, poly(p-benzamide), polyarylethersulfoneketone, aramid fiber, poly(aromatic sulfone) fiber, or polyolefin; and polymerization monomers of the polyolefin comprise at least one of ethylene, propylene, 1-butene, 1-pentene, 1-hexene, 1-octene, 4-methyl-1-pentene, cyclobutene, cyclopentene, or cyclohexene.
